(19) United States
(12) Patent Application Publication
(10) Pub. No.: US 2010/0299517 A1
(43) Pub. Date: Nov. 25, 2010

(54) Network System with a Plurality of Networked Devices with Various Connection Protocols

(75) Inventors: Vedran JUKIC, Rovini (HR); Vaghinag Hagop Zakian, Millbrae, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Nuvon, Inc.

(21) Appl. No.: 12/714,621

(22) Filed: Mar. 1, 2010

Related U.S. Application Data
(60) Provisional application No. 61/180,807, filed on May 22, 2009.

(51) Int. Cl. H04L 9/00; G06F 12/14

(52) U.S. Cl. 713/150; 713/193

(57) ABSTRACT

Methods and devices for retrieving data from a variety of devices, such as biomedical devices, are disclosed. In an embodiment, a communications path is established between a device manager and a device configured to collect data from a patient. A device type associated with the device is detected. Based on the device type, connections settings required to exchange data between the device manager and the device are requested from a first server. A patient identifier is also obtained. The patient identifier is sent to a second server, which may be the same as the first server. Verification of the patient identifier is received at the device manager from the second server. Data is then received at the device manager from the device. Upon receipt, the data is either stored in a storage or the data is sent via an encrypted communication channel to a server for data format conversion.

### CROSS REFERENCE TO RELATED APPLICATIONS

This patent application claims the benefit of U.S. Provisional Patent Application No. 61/180,807 filed on May 22, 2009, entitled “NETWORK SYSTEM WITH A PLURALITY OF NETWORKED DEVICES WITH VARIOUS CONNECTION PROTOCOLS,” which is incorporated by reference herein in its entirety.

### BACKGROUND

In today's society, data networks are becoming more integral with everyday home, office, commercial, healthcare, and industrial life. The ability to monitor, control, and access a plurality of devices from a remote location allows for optimization of time and resources. Unfortunately, as the size, scope, and variety of devices and networks increases, the problem of compatibility and response time may become an issue in some networks and network implementations. Devices developed by various designers and manufacturers may use a variety of network and control protocols in both hardware and software, thus possibly creating issues with compatibility.

### SUMMARY

The present disclosure provides methods, devices, and systems for providing a flexible and secure data network.

In one embodiment, a method for networking devices is provided, that may comprise detecting a plurality of network devices, including a first network device and a second network device, connected to a network, determining a first communication protocol associated with the first network device based on a first network device profile, querying a database for a first configuration profile associated with the first network device profile, retrieving the first configuration profile, storing the first configuration profile, executing the stored first configuration profile for configuring a first terminal of a network communication interface for communication with the first network device using the first configuration profile, determining a second communication protocol associated with the second network device based on a second network device profile, querying a database for a second configuration profile associated with the second network device profile, retrieving the second configuration profile, storing the second configuration profile, executing the stored second configuration profile for configuring a second terminal of the network communication interface for communication with the second network device using the second configuration protocol, simultaneously receiving data from the first network device based on the first communication protocol and the second network device based on the second communication protocol, wherein the first communication protocol and the second communication protocol are different, and communicating the received data from the first network device and the second network device, wherein communicating the received data from the first network device and the second network device comprises encrypting the data using a stream cipher encryption scheme, wherein the stream cipher encryption scheme is dependent upon the communicated data.

In one embodiment, a device manager is provided that may comprise a control unit, a network communication interface coupled to the control unit, and a memory for storing instructions which, when executed by the control unit, causes the control unit to detect a plurality of network devices, including a first network device and a second network device, connected to a network, determine a first communication protocol associated with the first network device based on a first network device profile, query a database for a first configuration profile associated with the first network device profile, retrieve the first configuration profile, store the first configuration profile, execute the stored first configuration profile for configuring a first terminal of the network communication interface for communication with the first network device using the first configuration profile, determine a second communication protocol associated with the second network device based on a second network device profile, query a database for a second configuration profile associated with the second network device profile, retrieve the second configuration profile, store the second configuration profile, execute the stored second configuration profile for configuring a second terminal of the network communication interface for communication with the second network device using the second configuration profile, simultaneously receive data from the first network device based on the first communication protocol and the second network device based on the second communication protocol, wherein the first communication protocol and the second communication protocol are different and communicate the received data from the first network device and the second network device, wherein communicating the received data from the first network device and the second network device comprises encrypting the data using a stream cipher encryption scheme, wherein the stream cipher is encryption scheme is dependent upon the communicated data.

In one embodiment, a network system is provided that may comprise a memory unit, a database stored in the memory unit, one or more device managers coupled to the memory unit, the device managers comprising, a control unit, a network communication interface coupled to the control unit, and a memory for storing instructions which, when executed by the control unit, causes the control unit to, detect a plurality of network devices, including a first network device and a second network device, connected to a network, determine a first communication protocol associated with the first network device based on a first network device profile, query a database for a first configuration profile associated with the first network device profile, retrieve the first configuration profile, store the first configuration profile, execute the stored first configuration profile for configuring a first terminal of the network communication interface for communication with the first network device using the first configuration profile, determine a second communication protocol associated with the second network device based on a second network device profile, query a database for a second configuration profile associated with the second network device profile, retrieve the second configuration profile, store the second configuration profile, execute the stored second configuration profile for configuring a second terminal of the network communication interface for communication with the second network device using the second configuration profile, simultaneously receive data from the first network device based on the first communication protocol and the second network device based on the second communication protocol, wherein the first communication protocol and the second communication protocol are different, and communicate the received data from the first network device and the second network device, wherein communicating the received data from the first network device and the second network device comprises encrypting the data using a stream cipher encryption scheme, wherein the stream cipher encryption scheme is dependent upon the communicated data, and a plurality of network devices coupled to the network communication interface of the one or more device managers.

### BRIEF DESCRIPTION OF THE DRAWINGS

FIG. 1 is a representation of a system for monitoring, controlling, or acquiring data from a plurality of devices in a network system for use in one or more embodiments of the present disclosure;

FIG. 2 illustrates communication pathways between network entities in one or more embodiments of the present disclosure;

FIG. 3 is a flow chart illustrating a method of compressing a data stream in one embodiment;

FIG. 4 is a flow chart illustrating a method of updating a data field in one embodiment;

FIG. 5 is a flow chart illustrating a transformation used for direct transformation between XSL and XML in one embodiment;

FIG. 6 is a flow chart illustrating one embodiment for establishing a remote procedure call (RPC) connection between a server and a network device;

FIG. 7 is a block diagram of a device manager for use in one or more embodiments of the present disclosure;

FIG. 8 is a block diagram of a general architecture of a device manager in one embodiment of the present disclosure;

FIG. 9 is a flow chart illustrating a method of encrypting a data stream in one embodiment of the present disclosure;

FIG. 10 is a flow chart illustrating the workflow for a processor with application programming interface (API) extensions support in one embodiment;

FIG. 11 is a flow chart illustrating steps for initializing a network in one to embodiment of the present disclosure;

FIG. 12 is a flow chart illustrating steps for monitoring a device in a network system in one embodiment;

FIG. 13 is a flow chart illustrating steps for establishing a data connection between a client terminal and a device in a network in one embodiment;

FIG. 14 is a flow chart illustrating steps for establishing a data connection between a remote terminal and a device in a network in one embodiment;

FIG. 15 is a flow chart illustrating steps for automatically connecting a receiver to a device manager in one embodiment;

FIGS. 16A and 16B are block diagrams illustrating a random number generating device using quantum states of an FPGA for use in one or more embodiments of the present disclosure;

FIG. 17 is a flow chart illustrating steps for verifying a user at a computer terminal according to one embodiment;

FIG. 18 illustrates a method of transferring data over a network in one embodiment of the present disclosure;

FIGS. 19A, 19B, and 19C illustrate methods of transferring data between a network device and one or more client terminals according to embodiments of the present disclosure;

FIG. 20 is a flow chart illustrating a system for forwarding data from a network device in one embodiment;

FIG. 21A is a diagram illustrating an exemplary system having a device manager according to an embodiment of the present disclosure;

FIG. 21B illustrates a method of transferring data over a network in one embodiment of the present disclosure;

FIG. 21C is a diagram illustrating an exemplary system having a device manager according to an embodiment of the present disclosure;

FIG. 22 illustrates device manager connectivity in one embodiment;

FIG. 23 illustrates an exemplary device manager for use in one or more embodiments of the present disclosure;

FIG. 24 illustrates an exemplary data center for use in one or more embodiments of the present disclosure;

FIG. 25 is a diagram illustrating connectivity of an exemplary gateway device for use in one or more embodiments of the present disclosure;

FIG. 26 depicts an exemplary hospital environment for use in one or more is embodiments of the present disclosure;

FIG. 27 depicts exemplary environments for use in one or more embodiments of the present disclosure; and

FIG. 28 is a flowchart illustrating a method of receiving data according to an embodiment of the present disclosure.

### DETAILED DESCRIPTION

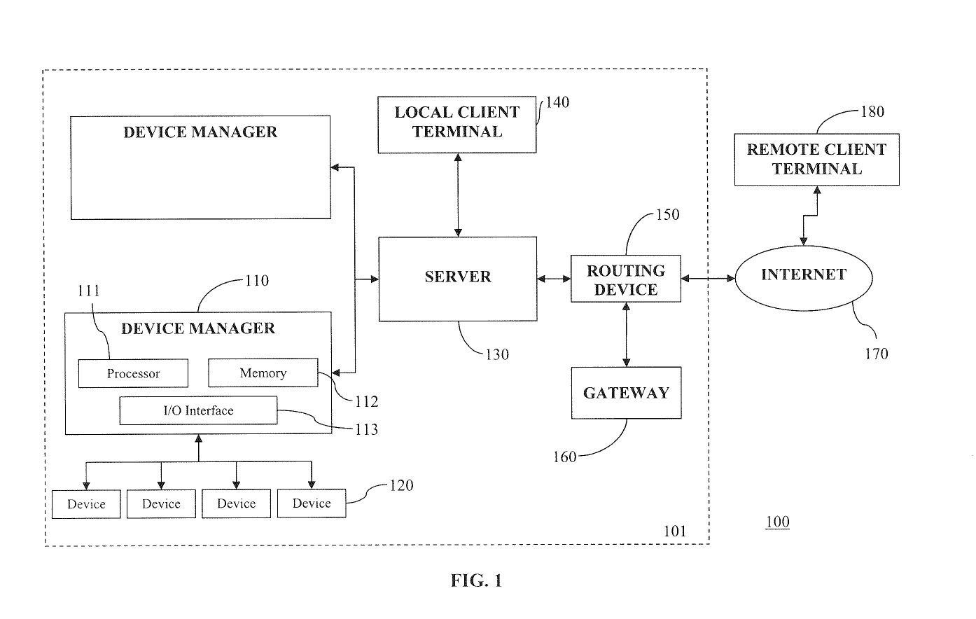

FIG. 1 is a representation of a system for monitoring, controlling, or acquiring data from a plurality of devices in a network system for use in one or more embodiments of the present disclosure. In one embodiment, the network system 100 may include one or more device managers 110. In another embodiment, the network system 100 may include a plurality of devices 120. In yet another embodiment, the network system 100 may include a networked data storage device, such as a server 130. In another embodiment, the network system 100 may include one or more local client terminals 140 or remote client terminals 180. In yet another embodiment, the network system 100 may include a network routing device 150 and/or a network gateway 160.

Referring to FIG. 1, a device manager 110 in one embodiment may be a networked hardware device. The device manager 110 may be connected to a plurality of devices 120 via an input/output (I/O) interface 113, such as a basic input/output system (BIOS). In one embodiment, the plurality of devices 120 may connect to the device manager 110 via one or more different network connection protocols. The network connection protocols may vary in hardware, software, or a combination of the two. In one aspect, examples of connection protocols may include, but are not limited to, unidirectional or bidirectional Ethernet/local area network (LAN), wireless local area network (WLAN), universal serial bus (USB), wireless universal serial bus (Wireless USB), parallel interface, RS-232 serial interface, RS-422 serial interface, RS-485 serial interface (Modbus; Profibus), FireWire, universal asynchronous receiver/transmitter (UART), small computer system interface (SCSI), WiFi, Zigbee, Bluetooth, radio frequency (RF), infrared (IR), fiber optic, high-definition multimedia interface (HDMI), S-video, RCA connector, TRS connector, coaxial cable, hypertext transfer protocol (HTTP), file transfer protocol (FTP), Internet protocol suite (TCP/IP), open systems interconnection (OSI), universal plug and play (UPnP), internet SCSI (iSCSI), network file systems protocol, or simple object access protocol (SOAP).

Still referring to FIG. 1, in one embodiment, a device manager 110 may include a memory 112 and one or more processors 111 coupled to the I/O interface 113. The memory 112 may include one or more sets of instructions related to connection, security, display, monitoring, transforming data, analyzing data, filtering data, and/or control protocols of the devices 120 connected to the device manager 110 via the I/O interface 113. Each set of instructions may correspond to a particular device 120 used within the network system 100. In another embodiment the one or more processors 111 may execute the one or more sets of instructions stored in the memory 112 corresponding to particular devices 120. The sets of instructions may be used in conjunction with the devices 120 for, among others, receiving, generating, and/or sending device specific events. The one or more processors may be, but are not limited to, a central processing unit (CPU), a microprocessor, a graphics processing unit, a network processor, a front end processor, a coprocessor, a microcontroller, an application specific integrated circuit (ASIC) or a combination thereof. In another embodiment, each device 120 connected to the device manager 110 may have a dedicated processor 111 and/or a dedicated memory 112, whereby the dedicated memory contains all the instructions related to connection, security, display, monitoring, transforming data, analyzing data, filtering data, and/or control protocols of the particular corresponding device 120, and the stored instructions are executed by the dedicated processor 111.

In one embodiment, the device manager 110 may automatically determine the types of the devices 120 connected via the I/O connection interface. The automatic determination may be implemented by use of a detection algorithm. The algorithm may be based upon a listing of known devices. The device is manager may be programmed to transmit and/or receive a query and analyze a response or received transmission. Based upon the received transmission, the device manager may analyze the transmission and compare the characteristics of the transmission to the listing of known devices for automatic determination of the type of the connected devices 120. In one aspect, from the list of known devices, the devices may be categorized based upon various characteristics or traits, such as data transmission protocols. The categories may be further sub-categorized one or more times. Categorizing the list of devices allows for comparison to a limited number of the list of devices to the received transmission, by limiting the scope of the search to only the category or categories to which characteristics of the received transmission match. The list may be narrowed one or more times based on one or more characteristics until the device type is determined.

The devices 120 connected to the device manager 110 may be legacy devices designed as stand-alone devices and not initially configured for connection to a network system. In one embodiment, the I/O interface 113 may include a hardware I/O connection interface used by the legacy device. In such a case, the set of instructions stored on the memory 112 and executed by the processor 111 of the device manager 110 may include connection protocol information for converting data signals from the legacy device into data signals that may be transported across a network system 100.

In one embodiment, each set of instructions used by the device manager 110 may be specifically tailored to a specific device 120 or device type connected to the device manager 110 in the network system 100. A plurality of the sets of instructions used by the device manager 110 may be stored in at designated location in the network system 100, such as in a networked data storage device, such as a server 130. The server 130 may store all or some of the available sets of instructions used by the device manager 110, and may be configured to transfer specific sets of instructions to a specific device manager 110 based upon which devices 120 are connected to the device manager 110.

In another embodiment, a device manager 110 may further include one or more additional components (not shown). Such components may include, among others, a display, such as a liquid crystal display (LCD), plasma display, light emitting diode (LED) display, a dot-matrix display, or a seven segment display, an auditory component, such as a speaker, a vibratory component, or a battery power component.

In one embodiment, the electronic components of a device manager 110 may be an integrated circuit (IC). In a further embodiment, the integrated circuit may be a system-on-chip IC. The system-on-chip configuration may integrate all the components of the device manager 110 on a single IC.

In another embodiment, the device managers 110 may be software algorithms. In one embodiment, the device manager software algorithms may be virtual machines. Virtual machines may be software programs configured to act like hardware devices. In one embodiment, the device manager software algorithms may be implemented on existing computer devices on the network 100. In another embodiment, the device manager software algorithms may be implemented on a dedicated device for connection to the network 100.

In one embodiment, each device manager 110 may be set up in a peer-to-peer mode for mutual data exchange with the connected devices 120. The device managers 110 may be configured to monitor, analyze, convert, filter and/or transform data streams received from the connected devices 120, or receive and generate device specific events, such as alarms, warnings, or maintenance requests.

In another embodiment, data received from the devices 120 may be monitored, analyzed, converted, filtered, and/or transformed in real-time. In other embodiments, the data received from the devices 120 may be monitored, analyzed, converted, filtered, and/or transformed continuously, periodically, or discretely.

In one embodiment, data received from the devices 120 may be transmitted to a receiver device on the network 100. In one configuration, the data received from the devices 120 may be transmitted to the server 130. In another configuration, the data received from the devices 120 may be transmitted to a dedicated memory (not shown) for storing data received from the devices 120. Transmission may be achieved via wired or wireless communication.

In another embodiment, the devices 120 may be connected to the device manager 110 via the power supply connections of the devices 120. The device manager 110 may be configured to monitor and/or control the power supplied to the devices 120, and one or more algorithms may be implemented in the device manager 110 whereby the one or more algorithms are used to calculate data measured by the connected devices 120 based upon the power consumption of the devices 120. The values obtained from the algorithmic calculations may be transmitted to the sever 130 or various receiver devices or user terminals on the network. In another embodiment, a peripheral device may be connected between the devices 120 and the device manager 110 for power monitoring and/or control.

In one embodiment, alarms or warnings may be generated in the form of a data stream sent to a client terminal. In another embodiment, alarms or warnings may be generated in the form of a visual, auditory, or tactile alarms or warnings or a combination thereof. In one aspect, the visual, auditory, or tactile alarms or warnings may be executed at a local client terminal 140 or a remote client terminal 180. In another aspect, the visual, auditory, or tactile alarms or warnings may be executed at a device manager 110. In another aspect, the visual, auditory, or tactile alarms or warnings may be executed at one or more devices 120. In another aspect, the visual, auditory, or tactile alarms or warnings may be executed at a dedicated alarm device (not shown) on the network.

Still referring to FIG. 1, in one embodiment, a local client terminal 140 may include software that resides in a workstation within the local network 101. The local client terminal 140 software may provide a user interface for technicians or other authorized personnel to communicate with the device managers 110 or send information to or receive information from the devices 120 of the network 100. In another embodiment, the local client terminal 140 may be hardware deployed on the network 100 for use exclusively as a local client terminal 140.

In one embodiment, the server 130 may provide, among others, connectivity protocols, network security, authentication, encryption, or data recording. In one aspect, the server 130 may provide user log-in authentication or verification, device authentication, data encryption/decryption, or data storage.

In one embodiment, the server 130 may be a software program that resides in a computing device within the network 100. The server may include an independent operating system (OS), wherein the software program is configured for execution on the hardware of a computing device within the network 100 regardless of the other software, such as operating systems, currently employed on the computing device. In one aspect, the server may be scaled across multiple machines, thus optimizing processing power and for faster networking capabilities, and further to prevent network crashes due to single machine malfunction. In another embodiment, the server 130 may be a hardware device deployed exclusively as a server 130.

A gateway 160 may be connected to the network 100 in one or more embodiments of the present disclosure. The gateway 160 may be used for enhanced security by providing a layer of security and authentication between a remote client 180 and the server 130, device managers 110, or devices 120.

In another embodiment, a routing device 150 using reverse TCP connections, HTTP/HTTPS proxies or SOCKS protocols to avoid firewalls may be incorporated. The routing device may be a layer 4 (UDP/TCP) and layer 7 (HTTP Proxy, SOCKS IV; V) router and may be used to send data packets to one or more machines on the network 100 that are located behind a single IP address. The layer 4-7 router is on the transport layer of the network and may use SOCKS protocols and HTTP/HTTPS proxies for firewall avoidance to allow for external remote client terminals 180 to connect to a server 130 that may be located behind a firewall of a network.

In one embodiment, the network system 100 may be a healthcare network and the plurality of devices 120 may be medical devices such as patient monitors, infusion pumps, ventilators, oxygen meters, anesthesia equipment, fetal monitors, heart monitors, electrocardiograph (EKG) machines, magnetic resonance imaging (MRI) machines, X-ray machines, and computed tomography (CT) scanners. In another embodiment, the network system 100 may be a home healthcare network and the plurality of devices 120 may be home healthcare network devices.

In another embodiment, the network system 100 may be an office or information technology (IT) network and the plurality of devices 120 may be devices such as routers, firewalls, telephony systems, voice over IP (VoIP) systems, voicemail servers, video servers, virtual servers, workstations, printers, scanners, personal computers, copiers, remote terminal units (RTUs), or programmable logic controllers (PLCs).

In another embodiment, the network system 100 may be a financial system network and the plurality of devices 120 may be devices such as automated teller machines (ATM), and devices used for financial data mining, personal financial agents, financial transaction integrity checking, or fraud detection.

In another embodiment, the network system 100 may be a utility network, such as an electrical power network, a water/sewer network, a natural gas network, or a communications network, and the plurality of devices 120 may be devices such as power transformers, power regulators, water/sewer distribution devices, water/sewer treatment devices, natural gas distribution devices, communication routers, remote terminal units (RTUs), programmable logic controllers (PLCs), or various other devices associated with utilities networks.

In another embodiment, the network system 100 may be a building network, and the plurality of devices 120 may be devices associated building functions including security, heating, ventilating, and air conditioning (HVAC), power, communication, and others.

In another embodiment, the network system 100 may be a production line network and the plurality of devices 120 may be a plurality of manufacturing devices.

In another embodiment, the network system 100 may be a home network and the plurality of devices 120 may include, among others, personal computing devices, home use appliances, home communication devices (for example telephone, fax, modem, cell phone), or home electronics and apparatus'.

In another embodiment, the network system 100 and the device managers 110 may support industry device protocols including, Healthcare Information and Management Systems Society (HIMSS) protocols, Supervisory Control And Data Acquisition (SCADA) protocols, Rombus protocols, LON protocols, and others.

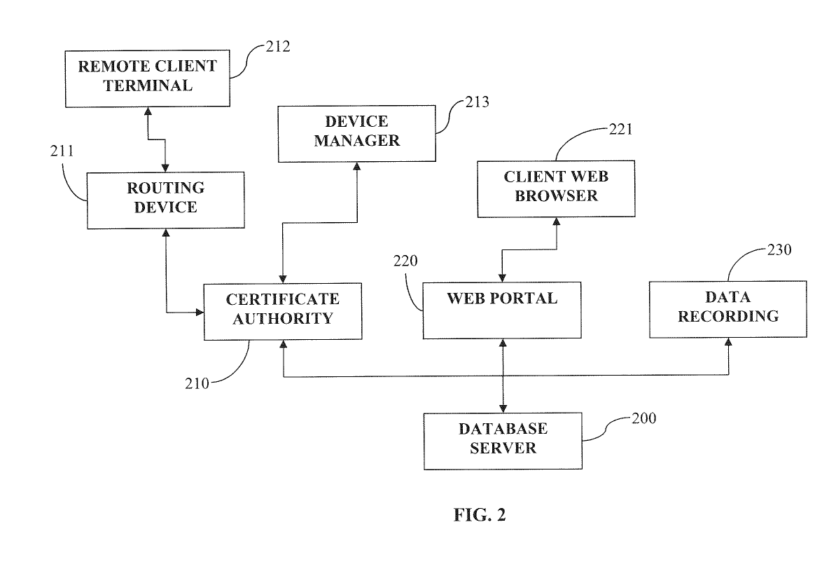

FIG. 2 illustrates communication pathways between network entities in one or more embodiments of the present disclosure. Referring to FIG. 2, in one embodiment, the server 130 (FIG. 1) may be a database server and an exemplary type of database server 200 may be a relational database server. A relational database may be built using tables of data sequences and determining relations between data sequences that have the same desired attributes. The tables of a relational database may be organized in rows and columns, and the relations defined as a set of fields (rows), which represent an object, such as a physical object or concept, and information about said object that may have the same attributes (columns). In one embodiment, the attribute data may fall under predetermined domains, or possible values, or conform to the same constraints. For example, as shown below in Table 1, in a network, a table in the relational database may include fields such as device serial number and related attributes including device type, device location, device model, manufacturer, input/output protocol type, etc. Other tables may be for user access, for example, with fields such as user name or number, and related attributes including access level and display preferences, such as graphics, text size, and text style.

TABLE 1
Device Relations

| Serial | Device | | Model | | |
|---|---|---|---|---|---|
| Number | Type | Location | Number | Manufacturer | I/O |
| Ser. #1 | Device A | Bldg. 1 | Model A | Mfg. A | Ethernet |
| Ser. #2 | Device A | Bldg. 9 | Model B | Mfg. B | Ethernet |
| Ser. #3 | Device B | Bldg. 3 | Model C | Mfg. C | Parallel |
| Ser. #4 | Device C | Bldg. 3 | Model D | Mfg. B | USB |
| Ser. #5 | Device D | Bldg. 1 | Model E | Mfg. A | Ethernet |
| Ser. #6 | Device C | Bldg. 3 | Model F | Mfg. C | USB |
| Ser. #7 | Device A | Bldg. 1 | Model A | Mfg. A | Ethernet |
| Ser. #8 | Device E | Bldg. 2 | Model G | Mfg. D | Ethernet |

The relational database may contain a plurality of different tables, and each table may contain a plurality of fields related by a plurality of various attributes. In one embodiment, data domains may also fall under various constraints, including the data for a particular attribute of a field being limited to, for example, an integer, a certain number of characters, or a symbol. Constraints on data domains may be used for error checking. If the data associated with an attribute of a field is not within a predetermined constraint, it may be an indication of an error in the data stream.

Additions, deletions, updates, or searches may all be done by accessing the database tables by the use of query language commands. Relational databases may be accessed through the Structured Query Language (SQL) query language, however other query languages include, among others, QUEL and .QL query languages. Queries may be used to access the database to search the database for specific desired fields or attribute values. Attribute data for a particular field may also include foreign keys. A foreign key may be a reference identifying an attribute column or set of columns in a referencing table of the database to another referenced table. Software, known as a database management system (DBMS), may be used for managing databases, with a relational database management system (RDBMS) being used for management of a relational database by grouping the relations of data sequences of the relational database.

Within the scope of the present disclosure, in other embodiments, other types of database servers 200 may include, for example, a hierarchical database, a network database, an object database, an object-relational database, or others.

In a hierarchical model database, the data may be organized in a hierarchical tree structure. The data structure may make use of parent child relationships, where data values may have numerous child data values, but only a single parent data value. A network model database, compared to a hierarchical model, may have data values where parent data values may have multiple child data values, and additionally child data values may also have multiple parent data values, thus forming a lattice type structure.

In another embodiment, an object database may be implemented. In an object database, information may be represented in the form of computer programming language objects. Object databases can be designed to work with object-oriented programming languages, such as Java, Python, C#, Visual Basic, C++, and others, or alternatively, an object database can have its programming language. Since object databases are designed to work with object-oriented programming languages, the programming language and the database scheme both use the same definitions. Similar to relational databases, object databases make use of a query language such as Object Query Language (OQL). In one embodiment, a difference between relational databases and object databases may be that while relational databases use a query language to perform searches of the database, in object databases data may be found by following pointers. Following pointers, also referred to as navigational access, may be done by following references from other objects. This technique may be particularly useful when a specific search route is defined, however, may be slower than the searches of a relational database in the case of general-purpose queries.

In yet another embodiment, an object-relational database may be implemented. An object-relational database may be considered a hybrid between a relational database and an object database. The object-relational database is similar to a relational database model, however it uses an object-oriented programming language scheme, similar to that of an object database. An object-relational database query language may also allow for query searches similar to that of a relational database.

Referring back to FIG. 2, one type of relational database server 200 for use in one or more embodiments, is a Java server platform, such as a J2EE 1.4 Java Enterprise Edition server, programmable in the Java programming language. Examples of such Java Enterprise Edition platforms include Oracle Application Server, Sun Java System Application Server, and IBM WebSphere Application Server. In one aspect, the tables of the database, are associative arrays such as hash tables or in memory database tables. In memory database tables may be database tables that primarily rely on main memory storage for data storage as opposed to database tables relying on disk storage for data storage. The use of main memory for data storage may be faster than disk storage, therefore optimizing the database table for more timely responses for database operations, such as time critical operations. The database tables may be optimized for performance with a specific query language engine, such as, SQL's MySQL, Oracle SQL, or Microsoft SQL query engines through, for example, the Java Database Connectivity Application Programming Interface. In one configuration, the database may be optimized for performance with multiple query engines.

In one embodiment, server modules may be coupled to the database server 200 and communication between the database server 200 and the server modules may be through extensible markup language remote procedure call protocol (XML-RPC). In other embodiments, communication between the database server 200 and the server modules may be through protocols such as, remote procedure protocol (RPC), Java remote procedure invocation, local procedure call, transmission control protocol (TCP), simple object access protocol (SOAP), hypertext transfer protocol (HTTP), simple mail transfer protocol (SMTP), or others. Referring still to FIG. 2, in one embodiment, server modules may be a certificate authority module 210, a web portal 220, or a data recording module 230.

In one embodiment, data streams may be transmitted between the various components and modules using a lossless compression method or scheme in order to optimize the speed and performance of the network without sacrificing quality resulting in data loss during transmission. This may be accomplished through detecting patterns of repeating data and compressing such patterns by replacing the pattern with a smaller replacement equivalent data bit, thus compressing the data stream.

In one embodiment, the compression algorithm is optimized to transfer TCP and UDP frames up to 2048 bytes.

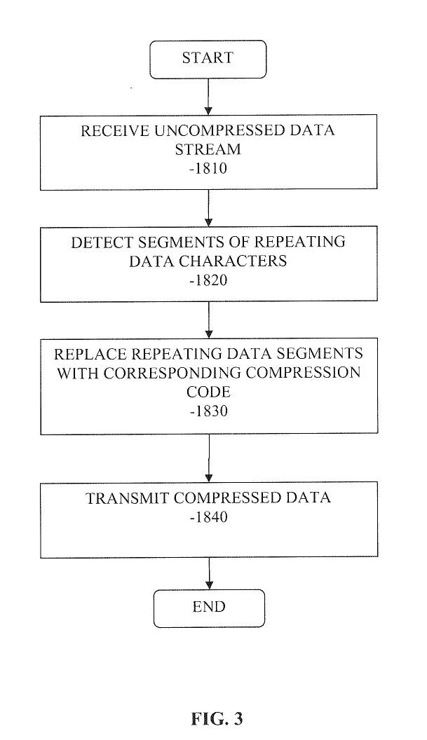

FIG. 3 is a flow chart illustrating a method of compressing a data stream in one embodiment. Referring to FIG. 3, a stream of uncompressed data is received (1810). The uncompressed data stream is analyzed and segments of repetitive data are detected (1820). Additionally, while segments of repetitive data are detected, segments of the data stream comprising unique or non-repetitive data are also determined. Each segment of repetitive data is then replaced with a corresponding compression code (1830). In one aspect, the compression method may be implemented such that the compression of short segments of repetitive code do not require the use of indexes or dictionary algorithms. By not utilizing these types of high memory resources, the compression method may be well suited for hardware and small device implementation. Additionally, the compression method may be used for compression of message types including, but not limited to, Internet Protocol Suite (TCP/IP), User Datagram Protocol (UDP/IP), Point-to-Point Protocol (PPP), and Point-to-Point Protocol over Ethernet (PPPoE).

Referring still to FIG. 3, when segments of repetitive data are detected, for example segments of data with 2, 3, or 4 consecutive same characters, a corresponding compression code is used to replace the segments of repeated data. In one embodiment, the compression of the data stream may adhere to the following encoding rules and compression codes:

| | | |
|---|---|---|
| 00h | 0000 0000 | End of Compressed Frame |
| 01h-03h | 0000 00xx | Next 1-3 bytes are LITERALS, copy them |
| 04h-07h | 0000 01xx | Next 0-4 (xxb) bytes are LITERALS, |
| | | append 00h after them |
| 08h-0Bh | 0000 10xx | Repeat last two bytes ONCE and Next 0-3 |
| | | (xxb) bytes are LITERALS, copy them |
| 0Ch-0Fh | 0000 11xx | Repeat last char TWO times and Next 0-3 |
| | | (xxb) bytes are LITERALS, copy them |
| 10h-1Fh | 0001 0 nnn | nnn = literalcount-4, code literals from |
| | | 4 to 11 in length |
| | 0001 1 nnn, | nnn = (literalscount) mod 8 |
| | mmmm mmmm | mmmm mmmm = (literalscount)/8 |
| | | code literals from 0 to 1536 in length |

IF 9<=repeating length segment<265
20h-3F 001 LLLLL, HHH nnOOO, OOOOOO xx
   LLLLL=(repeating length segment−9) mod 64
   HHH=(repeating length segment−9)/64
   nnOOO=(OFFSET−1)/64,
   nn is a combination of 00; 01; or 10; but not 11
   OOOOOO=(OFFSET−1) mod 64
   Repeat segment from cursor position -OFFSET−1 length times
   Next 0-3 (xxb) bytes are LITERALS, copy them
IF cursor position is LESS than 768, and 9<=repeating length segment<265
AND 1<=OFFSET <5
   001 LLLL, HHH 1 OO xx
      LLLLL=(repeating length segment−9) mod 64
      HHH=(repeating length segment−9)/64
      OO=(OFFSET−1)
      Repeat segment from cursor position -OFFSET−1 length times
      Next 0-3 (xxb) bytes are LITERALS, copy them
IF cursor position is Greater or Equal 768, and 9<=repeating length segment<265
AND 1<=OFFSET <3
   001 LLLL, HHH 11 O xx
      LLLLL=(repeating length segment−9) mod 64
      HHH=(repeating length segment−9)/64
      O=(OFFSET−1)
      Repeat segment from cursor position -OFFSET−1 length times
      Next 0-3 (xxb) bytes are LITERALS, copy them
IF 3<=repeating length segment<9
40h-FF LLL nnOOO, OOOOOO xx
   LLL=(repeating length segment−1)
   nnOOO=(OFFSET−1)/64,
   nn is a combination of 00; 01; or 10; but not 11
   OOOOOO=(OFFSET−1) mod 64
   Repeat segment from cursor position -OFFSET−1 length times
   Next 0-3 (xxb) bytes are LITERALS, copy them
IF cursor position is LESS than 768, and 3<=repeating length segment<9
AND 1<=OFFSET <5
   LLL 1 OO xx
      LLL=(repeating length segment−1)
      OO=(OFFSET−1)
      Repeat segment from cursor position -OFFSET−1 length times
      Next 0-3 (xxb) bytes are LITERALS, copy them
IF cursor position is Greater or Equal 768, and 3<=repeating length segment<9
AND 1<=OFFSET <3
   001 LLLL, HHH 11 O xx
      LLL=(repeating length segment−1)
      O=(OFFSET−1)
      Repeat segment from cursor position -OFFSET−1 length times
      Next 0-3 (xxb) bytes are LITERALS, copy them

Referring back to FIG. 3, once compression is completed, the compressed data stream may be transmitted (1840) to an end-point device or server. The compression method may be used for compressing data streams, including image data. In one embodiment, the compression method may be used to compress data, such as image data, that must be segmented into smaller frames or shorter data stream lengths, for transmission to an end-point device. In other embodiments, other compression schemes may be implemented, such as a Lempel-Ziv-Welch (LZW) compression algorithm or other third-party compression schemes.

In one embodiment, the web portal 220 may be written in Java programming language and implemented on a J2EE 1.4 Java server platform. The web portal 220 may communicate with the database server 200 through XML-RPC calls in order to query the database server 200. In one aspect, if the web portal 220 is not on the same application server as the database server 200, for security purposes, the access control list (ACL) of the database server 200 may include the internet protocol (IP) address of the web portal 220.

In one embodiment, the web portal 220 may allow a technician or other authorized user access to the database server 200 through a client web browser 221. Example web browsers include, but are not limited to, Microsoft Internet Explorer, Mozilla Firefox, Netscape Navigator, Apple Safari web browser, etc. The client web browser 221 may communicate with the web portal 220 through hypertext transfer protocol (HTTP) or, for added security, through hypertext transfer protocol over secure socket layer (HTTPS). Other transfer protocols, such as file transfer protocol (FTP), may also be adapted for use in another embodiment. In one embodiment, when the queries and communication of data between the database server 200 and the web portal 220 is through XML-RPC calls, the data may be structured using, for example, live search algorithm, wherein the data is searched simultaneously while the search parameters are entered, transported via HTTP protocols, and presented on the client web browser 221 using, for example, stylesheet languages. Examples of stylesheet languages include cascading style sheets (CSS) or asynchronous JavaScript and XML (AJAX) for use with a hypertext markup language (HTML), extensible hypertext markup language (XHTML), or other markup language page displays. Other stylesheet languages that may be implemented in other aspects include extensible stylesheet language (XSL), document style semantics and specification language (DSSSL), and JavaScript style sheets (JSSS), or in other aspects, RSS feeds may also be used at the client web browser 221.

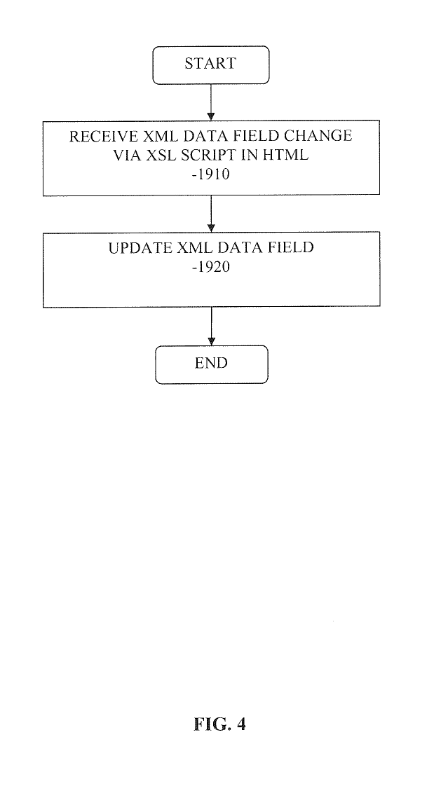

FIG. 4 is a flow chart illustrating a method of updating a data field. Referring to FIG. 4, in one embodiment, data fields, such as database information, may be displayed at a client web browser 221, in the form of an XML data through an XSL generated form displayed via the HTML web page. In another embodiment, the XML data through an XSL generated HTML form may be editable. Data displayed in the XSL form may be directly edited at via the client web browser 221 (1910). In one aspect, the names of input fields and hidden input fields may be carefully chosen such that a consequent algorithm at the server can reconstruct or extend the XML data set without additional intervention. As such, the data changes made in the XSL form edited via the client web browser 221 may be directly implemented in the XML data field (1920) of the database and thus the database need not be fully reconstructed each time a change is made to a data field of the database. In one embodiment, the edited data may be directly reconstructed into the XML database by using the following explanatory rules:

Begin with XML data record:

<ROOTNAME>

< RECORDNAME FIELD=”db field 1” />
< RECORDNAME FIELD=”db field 2” />
...
< RECORDNAME FIELD=”db field 3” />
< RECORDNAME FIELD=”db field 4” />
</ROOTNAME>

The following XSL will apply:

```
<input type=hidden VALUE=”tag” NAME=”ROOTNAME” />
  <xsl:for-each select=“ ROOTNAME ”>
    <xsl:for-each select=“ RECORDNAME ”>
      <input type=”hidden” VALUE =“rec-tag” >
        <xsl:attribute name=“NAME”>
          <xsl:value-of
          select=“concat(‘RECORDNAME’,‘_’,position( ))” />
        </xsl:attribute>
      </input>
      <input type=“text”>
        <xsl:attribute name=“VALUE”>
          <xsl:value-of select=“@FIELD”/>
        </xsl:attribute>
        <xsl:attribute name=“NAME”>
          <xsl:value-of
          select=
          “concat(‘RECORDNAME’,‘_’,position( ),‘_’,‘FIELD’)” />
        </xsl:attribute>
      </input>
      <input type=”hidden” VALUE =“rec” >
        <xsl:attribute name=“NAME”>
          <xsl:value-of
          select=“concat(‘RECORDNAME’,‘_’,
          position( ),‘_close’)” />
        </xsl:attribute>
      </input>
    </xsl:for-each>
  </xsl:for-each>
<input type=hidden VALUE=”tag” NAME=”ROOTNAME_close” />
```

Converts to HTML page by the browser:

...
<input type=hidden VALUE=”tag” and NAME=”ROOTNAME” />
<input type=”hidden” VALUE =“rec-tag”
NAME=”RECORDNAME_1” />
<input type=”text” VALUE =“ db field 1”
NAME=”RECORDNAME_1_FIELD” />
<input type=hidden VALUE=”tag” and NAME=”
RECORDNAME_1_close” />
<input type=”text” VALUE =“ db field 2”
NAME=”RECORDNAME_2_FIELD” />
<input type=hidden VALUE=”tag” and NAME=”
RECORDNAME_2_close” />
<input type=”text” VALUE =“ db field 3”
NAME=”RECORDNAME_3_FIELD” />
<input type=hidden VALUE=”tag” and NAME=”
RECORDNAME_3_close” />
<input type=”text” VALUE =“ db field 4”
NAME=”RECORDNAME_4_FIELD” />
<input type=hidden VALUE=”tag” and NAME=”
RECORDNAME_4_close” />
<input type=hidden VALUE=”tag” and NAME=”
RECORDNAME _close” />
...

POST BODY message generated by the browser:

...
<ROOTNAME=tag&>
<RECORDNAME_1=rec-tag&RECORDNAME_1_FIELD=db field
1&>
<RECORDNAME_1_close=tag&>
<RECORDNAME_2=rec-tag&RECORDNAME_2_FIELD=db field
2&>
<RECORDNAME_2_close=tag&>
<RECORDNAME_3=rec-tag&RECORDNAME_3_FIELD=db field
3&>
<RECORDNAME_3_close=tag&>
<RECORDNAME_4=rec-tag&RECORDNAME_4_FIELD=db field
4&>
<RECORDNAME_4_close=tag&>
<ROOTNAME_close=tag>
...

Converts back to XML dataset:

```
...
<ROOTNAME>
    < RECORDNAME FIELD=”db field 1” />
    < RECORDNAME FIELD =”db field 2” />
< RECORDNAME FIELD =”db field 3” />
< RECORDNAME FIELD =”db field 4” />
</ROOTNAME>
...
```

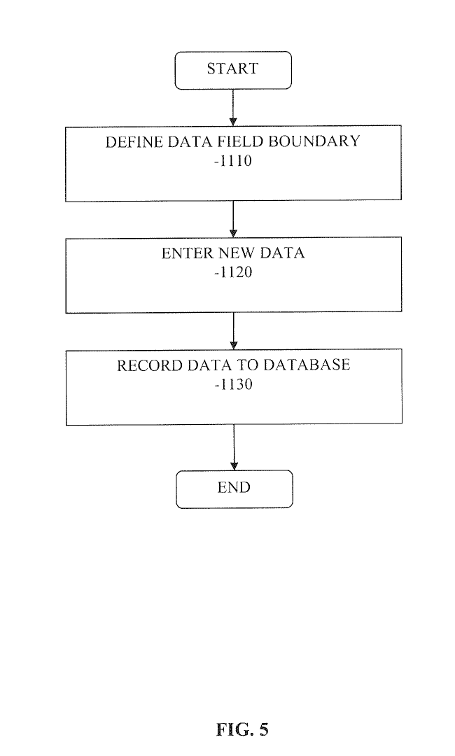

FIG. 5 is a flow chart illustrating a transformation used for direct transformation between XSL and XML in one embodiment. A direct transformation from XSL to XML may be used for optimized database updates. Referring to FIG. 5, in one aspect, data may be entered in XSL format at a web portal 220, for example, and the inputted data may be transformed directly to XML data for updating the database with minimal code rewriting, thus optimizing the system. This may be accomplished by first defining the boundary for the data is input (1110). The boundary definition may be done by using the following code:

Definition of the beginning of the XML field boundary:

<input type=hidden VALUE=“tag” NAME=“ROOTNAME” />

Definition of the closure of the XML field boundary:

<input type=hidden VALUE=“tag” NAME=“ROOTNAME_close” />

Once the boundary has been defined, the new data may be entered (1120) using the following code:

Beginning of the XML record:

<input type=hidden VALUE=“tag_rec” NAME=“RECORDNAME_{—}1” />

Closure of the XML record:

<input type=hidden VALUE=“tag” NAME=“RECORDNAME_{—}1_close” />

Once the data has been entered, the data may then be recorded directly into the XML database (1130) using the following code (with the field name “FIELD”):

```
<input type=hidden VALUE=”tag” NAME=”ROOTNAME” />
<input type=“text”>
    <xsl:attribute name=“VALUE”>
        <xsl:value-of select=“@FIELD” />
    </xsl:attribute>
    <xsl:attribute name=“NAME”>
        <xsl:value-of select=“FIELD” />
    </xsl:attribute>
</input>
<input type=hidden VALUE=”tag” NAME=”ROOTNAME_close” />
```

In one embodiment, the web portal 220 may be coupled to a memory to store user setup data for individual users accessing the database server 200 via a client web browser 221. User setup data may include customization of desired view. For example, a user may select a setup with more displayed text and fewer displayed graphics. In one embodiment, more CSS stylesheet language may be used for a setup with more displayed text, while more AJAX stylesheet language may be used for a setup with more displayed graphics. The individual setups for each user may be stored on a web portal memory and may be ported to any future web sessions, whether the future web sessions are accessed through the same computer or on a different machine.

Referring back to FIG. 2, database server 200 may also be in communication with a data recording module 230. In one embodiment, calls and access to the database server 200 are made through XML-RPC calls, and can be logged and posted to a data recording module 230 for, among others, data backup. In on aspect, session and event logs may be stored on a data recording module 230, not on the database server 200. In another embodiment, headers of the session and event logs and instructions to query the stored content may be stored within the database server 200. By storing only the headers and query instructions on the database server 200, newly generated data flow to the database server 200 may be kept to a minimum. The data recording module 230, in one configuration may be a separate coupled server device. In another configuration, the data recording module 230 may be a section of memory of the database server 200 allocated for data recording. In yet another configuration, the data recording module 230 may be a section of memory of a device connected to the network. In yet another configuration, the data recording module 230 may be located in a remote location not on the local network.

Still referring to FIG. 2, in another embodiment, another server module may be a certificate authority module 210. The certificate authority module 210 may communicate with the database server 200 using, for example, XML-RPC calls. The certificate authority server 210 may be used to verify the authenticity of device managers 213 or for checking the status of device managers 213 for indications of need for service, reprogramming, or controlling.

In one embodiment, the certificate authority module 210 may be in communication with, among others, a routing device 211, which may be in communication with remote client terminals 212. The certificate authority module 210, in one embodiment, may be used for log-in authentication or verification for users at the remote client terminals 212 or at local client terminals. In one embodiment, the certificate authority module may use digital certificates for verifying the authentication information for users at a remote client terminal 212 or at a local client terminal. Digital certificates may be a method of public key cryptography. In one configuration, digital signatures may use a private key for digitally signing a message and the digital signature may be authenticated and verified by use of a corresponding public key. Various public key cryptography protocols may be implemented in one embodiment, such a public key infrastructure (PKI). PKI is a protocol used to bind public encryption/decryption keys with respective user identities. This may be used for authenticating user log-in information for granting access to users at a remote client terminal 212 or at a local client terminal.

In another embodiment RSA public-key cryptography may be used for digital signing. RSA may involve three main steps; key generation, encryption, and decryption. In yet another embodiment, a web of trust scheme that uses self-signed certificates or simple public key infrastructure (SPKI) which is a key trust scheme may be implemented instead of a user identity authorization scheme. Communication between the certificate authority server 210 and the routing device 211 may be done through various communication protocols, such as remote procedure call (RPC).

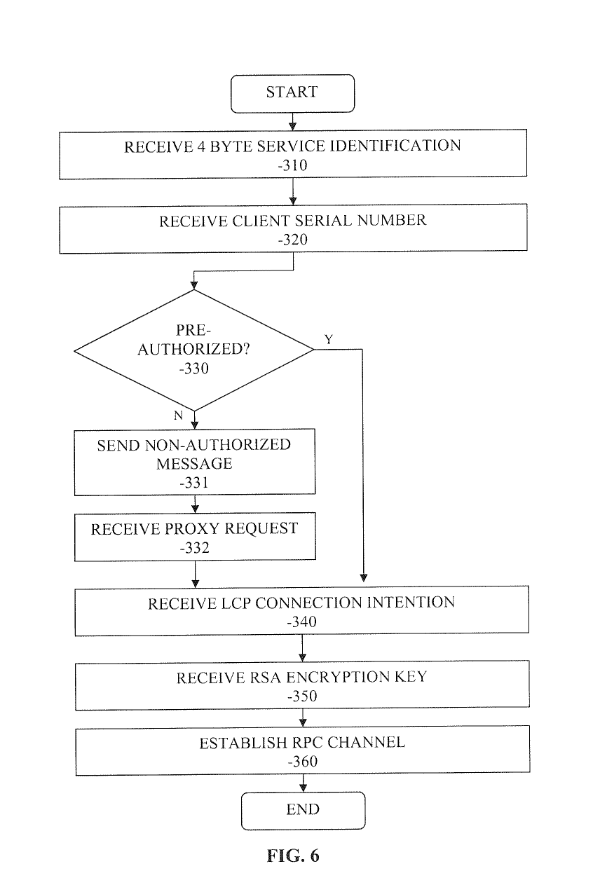

In one embodiment, a remote procedure call (RPC) protocol that may be used may be a 1024 or 2048 bit RSA security encrypted protocol. FIG. 6 is a flow chart illustrating one embodiment for establishing a remote procedure call (RPC) connection between a server and a network device. In one aspect, a network device may be a device initially configured for connection to a network or may refer to a device not initially configured for connection to a network, but connected to a network via configuration due to programming of a server, device manager, or other means. To establish the RPC channel, the server receives a 4 byte service identification (310) and a client serial number (320) from the client. The server checks to see if the serial number is pre-authorized (330). In the case that the serial number is not pre-authorized, a non-authorized message is sent (331). In response to the non-authorized message, a proxy request may be received at the server (332). After the proxy request is received, or the serial number is authorized, a link control protocol (LCP) connection intention protocol is received (340). The LCP connection intention protocol is followed by a 1024 or 2048 bit RSA encryption key (350). If the encryption key is acknowledged, an RPC channel is established (360).

Referring back to FIG. 1, in one embodiment, the database server 200 (FIG. 2) and the server modules may communicate with the device managers 110 to provide, among others, connectivity protocols, network security, authentication, encryption, or session recording.

In one embodiment, the device managers 110 may be hardware appliances. Each hardware device manager 110 provides connectivity to a server 130 and managed devices 120 through, for example, Ethernet interfaces. The device managers 110 are comprised primarily of a plurality of microcontrollers and connectivity interfaces, thus the hardware appliances may have no moving parts and may have low power consumption and heat dissipation. The physical size of the hardware device managers 110 may be from one rack unit (approximately 1.75 inches) in height and 19 inches or 23 inches in width, to half-rack unit in width (approximately 9.5 inches), to a small desktop footprint or a handheld size device manager 110. In other embodiments, the height may be taller or shorter than one rack unit, and/or the width may be smaller or larger than 9.5, 19, or 23 inches, depending upon the number of connectivity interfaces incorporated into the unit. Within the scope of the present disclosure, in other embodiments, connectivity between the device manager 110 and the database server 130 and the managed devices 120 may be achieved via unidirectional or bidirectional wireless local area network (WLAN), universal is serial bus (USB), Wireless universal serial bus (Wireless USB), parallel interface, RS-232, RS-422, or RS-485 serial interfaces, FireWire, universal asynchronous receiver/transmitter (UART), small computer system interface (SCSI), WiFi, Zigbee, Bluetooth, radio frequency (RF), infrared (IR), fiber optic, high-definition multimedia interface (HDMI), S-video, RCA connector, TRS connector, coaxial cable, or other connectivity methods.

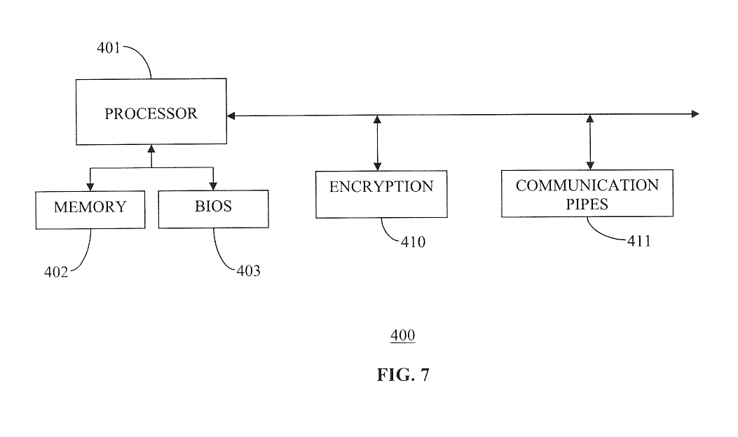

FIG. 7 is a block diagram of a device manager for use in one or more embodiments of the present disclosure. Referring to FIG. 7, in one embodiment, a device controller 400 may be comprised of a processor 401 coupled to a memory 402 and an I/O interface such as a basic input/output system (BIOS) 403. A device manager 400 for use in one or more embodiments of the present disclosure may include only one or as many as eight or 32 or 128 or more sets of instructions stored in the memory 402 corresponding to one or more devices 120 (FIG. 1) connected to the device manager 400 via the BIOS 403. The BIOS 403 may allow for each device controller to run independently. This allows for virtualization across hardware and software of a host machine, allowing the device controller to run independent of the host machine operating system. The sets of instructions stored in the memory 402 may be executed by the processor 401 for communication with the one or more connected devices 120. The memory 402 may include instructions for connection protocols, security, monitoring, analyzing, converting, or transforming data streams received from the connected device 120.

Referring still to FIG. 7, in one embodiment, the device manager 400 may include components such as an encryption component 410. The encryption component 410 may be used, for example, for device or user identification using various encryption/decryption protocols, including public key cryptography protocols, such a public key infrastructure (PKI). PKI is a protocol used to bind public encryption/decryption keys with respective user identities. This may be used for authenticating user log-in information for granting access to the devices 120 (FIG. 1). In another embodiment, a web of trust scheme that uses self-signed certificates or simple public key infrastructure (SPKI) which is a key trust scheme may be implemented instead of a user identity authorization scheme. Other components may include communication pipes 411, which may support a wide range of connection types and protocols including Internet Protocol Suite (for example TCP/IP, UDP/IP), HTTP, HTTPS, XML-RPC, modem, serial connections, parallel connections, wired or wireless universal serial bus (USB), RS-232, RS-485, RS-422 and the like.

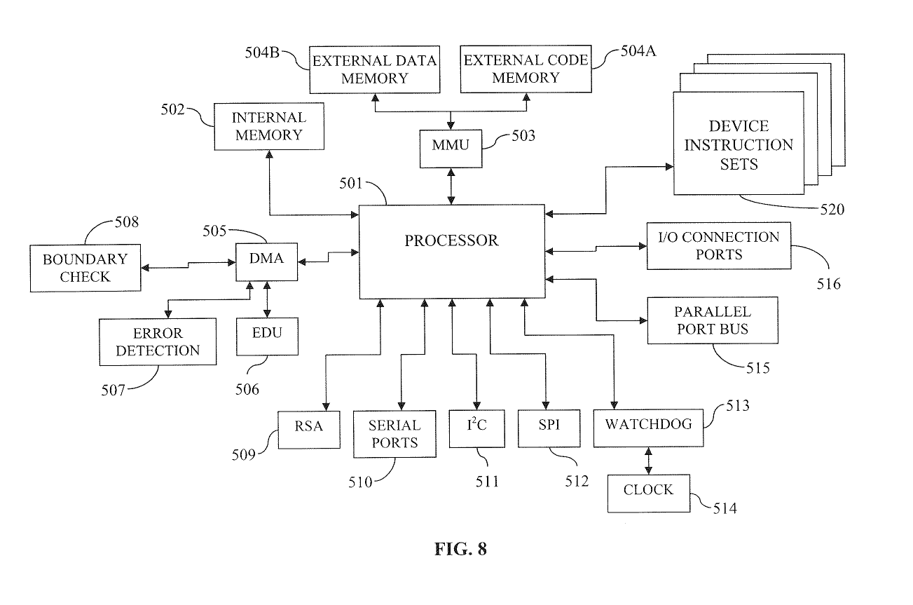

FIG. 8 is a block diagram of a general architecture of a device manager in one embodiment of the present disclosure. Referring to FIG. 8, in one embodiment, each device manager 110 (FIG. 1) may have a processor 111 that is a microcontroller, for example a 8051 microcontroller. The device manager 110 may include a processor 501, internal memory 502 and various input/output peripherals. Such input/output peripherals may include, among others, external code memory 504A, external data memory 504B, serial interface ports 510, parallel interface ports 515, an encryption/decryption unit 506, or a memory mapping unit 503.

In one embodiment, an 8051 microcontroller may be configured as a processor 112 of a device manager 110 (FIG. 1). In one embodiment, the 8051 microcontroller may include a single-chip Harvard architecture microcontroller, which physically separates storage and signal pathways for data memory and instruction memory. The separated memory for data and instructions allows for each memory to have separate and different characteristics, including word width, timing, and memory address structure. Instruction memory may be wider than data memory for cases in which there is more instruction memory than data memory. Further, instruction memory may be read-only memory (ROM), whereas data memory may be read-write memory, such as random-access memory (RAM). In one embodiment, information in the 8051 microcontroller is stored in three locations: internal on-chip memory, external code memory, and external data memory (XDATA).

In one embodiment internal on-chip memory may include one of two types of memory: internal RAM 502 and special function registers (SFRs). In one configuration, the internal RAM may be a 128 byte memory 502. The 128 byte internal RAM 502 may be supported with four 8 byte register banks (register banks 0 through 4, where bank 0 is the first 8 bytes, address space 00h-07h, bank 1 is the next 8 bytes, address space 08h-0Fh, and so on) located in the address space of 00h-1Fh. The register banks may be used for moving data from one location to another or for manipulating values. The 128 byte internal RAM 502 also may have bit memory from addresses 20h-2Fh for accessing bit variables or user-defined functions for use in the program instructions. The remainder of the 128 byte internal RAM 502 may also include up to 80 bytes of general usage internal RAM. These 80 bytes may be located in address space 30h-7Fh.

This address space is shared between frequently accessed user variables and storage space for the microcontroller operating stack. In one aspect, the remaining internal memory address space 80h-FFh is used for special function registers (SFR). Special function registers, as discussed in further detail below, may be control registers used to control specific functionalities of the microcontroller. In another configuration, the internal RAM may be a 256 byte memory. In this configuration, the address space from 00h-7Fh may still be allocated the same way as the internal 128 byte memory and the address space 80h-FFh may still be used for SFRs. The additional 128 bytes of internal RAM may be referenced through indirect addressing. Within the scope of the present disclosure, the internal RAM may include greater size memory such as 512 byte, 1 Megabyte (Mb), etc. memory, wherein the memory in excess of the first 128 bytes of RAM may be referenced through indirect addressing.

In one embodiment, device controller instructions may be up to 32 banks with 32 Kb mapped in the 8000h-FFFFh address range of the external code memory 504A connected through the port 2 (P2) register of the 8051 microcontroller. The external code memory 504A may be a 1 Mb flash memory, and in one configuration, may include instructions to handle flash programming or firmware for serial flash boot loading, mapped into address range 6000h-6FFFh. In one embodiment, the flash memory is serial flash memory. In another embodiment, the external code memory 504A may be read-only memory (ROM), erasable programmable read-only memory (EPROM), or others. In another embodiment, the external code memory 504A may be less than a 1 Mb memory, such as 512 Kb, or more than a 1 Mb memory, such as 2 Mb, 3 Mb, or more. In another embodiment, as discussed further below, by using dynamic memory mapping, code instructions can be stored in XDATA, thus allowing for write enabling.

In another embodiment, data may be stored in a 1 Gigabyte (Gb) external data memory (XDATA) 504B. The XDATA may be mapped into two banks of 16 kilobyte (Kb) address spaces. Using dynamic memory mapping, the first and second data banks can be mapped anywhere within the 1 Gb XDATA 504B, as long as each data bank stays within the 16 Kb address space boundary. In one embodiment, upon reset, the default data banks point to 00000000-00003FFF for the first data bank and 00004000-00007FFF for the second data bank within the 1 Gb XDATA 504B. However, using dynamic memory mapping, a memory management unit 503 may point to any 16 Kb address space located in the 1 Gb XDATA 504B for each of the two data banks. The two 16 Kb data banks, may be seen from the perspective of the main processor 501 as the first 32 Kb of contiguous RAM of the system, and may be mapped at 8000-FFFF (8000-BFFF for the first 16 Kb bank and C000-FFFF for the second 16 Kb bank) of the XDATA address space. As discussed above, code data may be stored in the 1 Gb external memory 504B as sets of 16 Kb data banks, and may be called in a similar fashion as the 16 Kb banks of data memory in the 1 Gb XDATA. In other embodiments, depending on the complexity of the device manager 105 (FIG. 1), the XDATA may be less than 1 Gb, for example 500 Mb or 250 Mb, or less, or for more complex device managers 105, the XDATA may be greater than 1 Gb, for example 2 Gb or more.

In other embodiments, special function registers may be control registers that control specific functionality of the microcontroller. That is, the SFRs may be used for controlling the mode in which the microcontroller may be operating. For example, the 8051 microcontroller may include a number of standard SFRs, including, ACC, B, DPL, DPH, SP, PSW, IE, IP, P0, P1, P2, and P3. The ACC, B, DPL, DPH, and SP registers may be considered as auxiliary registers, such that the functions of the registers may not directly configure 8051 functionality, however, the microcontroller may not function without them. The ACC, or Accumulator, SFR may be used for storing intermediate results during many functions performed by the microcontroller. The standard location for the ACC register in an 8051 microcontroller is at address E0h. The B register, much like the ACC register, may be used for temporarily storing values, for example during the multiply or divide functions. The standard location for the B register in an 8051 microcontroller is at address F0h. DPL and DPH (data pointer low and data pointer high) may be registers that work together to act as data pointers. The data pointers may be used as a reference or a pointer to a value stored in another memory address. Together, DPL and DPH represent a 16-bit value that can range from address locations 0000h-FFFFh, indicating the address to which the DPL and DPH registers may be pointing. The standard location for the DPL and DPH registers in an 8051 microcontroller are at addresses 82h (DPL) and 83h (DPH). Alternatively, a DPTR, or data pointer, register may be a 16-bit register that operates as a pointer. However, DPTR operations may require that only 1 byte (8-bits) be dealt with at a time, thus acting in generally the same manner as the combination of DPL and DPH. The SP, or stack pointer, register may point to the position of the stack in the internal RAM of the microcontroller in which a function is to be performed. For example, if the push operation of the stack is called, the data bit may be pushed into the stack at the position as indicated by the stack pointer. The initial value of the SP register may be set to 07h, which may specify the internal RAM stack to begin at address 08h (register bank 1) and begin expanding upwards from there. The standard location for the SP register in an 8051 microcontroller is at address 81h.

In one configuration, some of the special function registers may in some way control the function or operation of the microcontroller. For example, the PSW, or program status word, register may be used to store information relating to the current status of the running operation or program. The PSW register may contain a variety of flags, or markers, including the carry flag to indicate when an is operation resulted in an answer that is larger than the number of available data bits, an overflow flag which is similar to a carry flag but for signed operations, a parity flag to indicate whether the result of an operation resulted in an odd or even number of bits, or the register bank selector flags, which may indicate which register bank is currently selected. The PSW register has a standard address in an 8051 microcontroller of D0h. Other examples of SFRs that may control the operation of the microcontroller are the IE and IP registers. The IE, or interrupt enable, register may be used to enable and disable interrupts in the microprocessor function. The IE register is located at A8h in the standard 8051 microcontroller address layout. The IP, or interrupt priority, register is located at address B8h, and may be used for designating the priority of interrupt operations.

Interrupt priorities may be designated as either low or high, wherein a high priority interrupt may interrupt even if a low priority interrupt is currently running.

In yet another embodiment, other special function registers may control the input/output (I/O) ports. The standard 8051 microcontroller has four I/O ports: P0, P1, P2, and P3. Each I/O register is 8-bits, and each bit references one of the pins of the microcontroller. If applicable, for a standard 8051 microcontroller, P0 and P2 are pre-designated for use with external RAM 504B and external code memory 504A, respectively.

In one embodiment, special function registers in addition to the 8051 microcontroller standard SFRs may also be implemented. Such additional SFRs may include registers for control for dynamic memory mapping, direct memory access, virtual machine control, encryption/decryption units, checksums, timers, and watchdogs.

In one configuration, a SFR may be used to control the memory management unit (MMU) 503 which is used for dynamic memory mapping of the 1 Gb XDATA memory 504B and/or the 1 Mb flash code memory 504A. The MMU 503 may map the 16 Kb data banks of the 1 Gb XDATA into the logical address space of the microcontroller by translating the physical location of the requested 16 Kb data banks to logical addresses of the microcontroller internal memory 502.

In another configuration, a SFR may be used to control the direct memory is access (DMA) 505 feature of the microcontroller system. DMA 505 may allow for access to system memory for data transfer, without having to go through the processor 501, for example the main processor 501 of a 8051 microcontroller. This may keep the processor 501 from being overworked, allowing the processor power to be used for other operations and functions. The DMA 505 may be used to call, among others, an encryption/decryption unit (EDU) 506, an error detection unit 507, or a circular boundary check 508.

In one embodiment, the encryption/decryption unit 506 may perform encryption and decryption via a number of methods, such as, symmetric-key cryptography including stream ciphering and block ciphering, public-key cryptography including public-key encryption, digital signature standard (DSS), or RSA, and the like.

In one configuration, symmetric-key cryptography may use identical or related cryptographic keys for both encryption and decryption. The encryption and decryption keys may be related via a simple transform to go between the keys. Symmetric-key cryptography may be generally grouped in two main categories; stream ciphering and block ciphering.

Stream ciphering is a cryptographic technique whereby individual bits of data are encrypted individually by the use of a pseudorandom cipher bit stream, or keystream. In one configuration, the cipher bit stream uses an exclusive-or (XOR) operation for the transformation of the individual bits of data. The transformation of each individual bit varies during the encryption. Stream ciphers make use of a key, for example a 128-bit key. The key is used to generate a pseudorandom keystream, which is combined with each data bit of the data to be encrypted. The size of the key, for example 128-bits, 256-bits, 512-bits, is proportional to the security of the cipher, because the larger the key, the closer to true randomness the keystream will be. However, the larger the key, the more cumbersome it is to implement in encryption and decryption, thus a trade-off is made dependent upon the processing power of the system and the desired level of security. The transforms of a stream cipher may be generated in two ways: as synchronous stream ciphers, and as self-synchronizing (or asynchronous) stream ciphers. In synchronous stream ciphers, the keystream is generated independently of the data stream to be encrypted/decrypted. The independently generated keystream is then matched up with the data stream, and the data stream can be encrypted or decrypted. On the other hand, self-synchronizing stream ciphers uses several previous data bits to generate the keystream, thus being self-synchronized as the keystream self-synchronizes with the data stream after a number of bits has been received.

In one embodiment, an encryption/decryption technique may be a data dependent scheme. As such, a tracker symbol may be placed in the data stream as a place holder for decryption and the encryption may be based upon the data of the data stream itself.

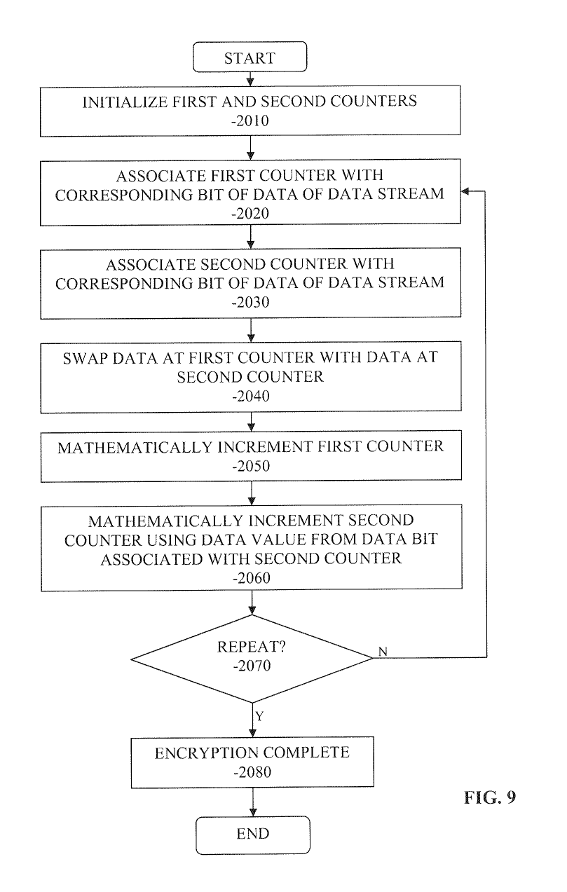

FIG. 9 is a flow chart illustrating a method of encrypting a data stream in one embodiment of the present disclosure. Referring to FIG. 9, in one embodiment, a first counter and a second counter are initialized (2010) based upon an initial encryption key. The first counter is associated with a corresponding data bit of the data stream (2020) based upon the initial encryption key. The second counter is also associated with a corresponding data bit of the data stream (2030) based upon the initial encryption key. In one embodiment, the data value of the data bit associated with the first counter and the data value of the data bit associated with the second counter are swapped (2040). Once the data bits have been swapped, the first counter is incremented using a mathematical function (2050). In one embodiment, the mathematical function used to increment the first counter is a modulo (mod) 256 function. The second counter is also incremented using a mathematical function. In one aspect, the second counter also incorporates the data value of the data bit associated with the second counter with the mathematical function to increment the second counter (2060). In this manner, the new value of the second counter is based on the data of the data stream itself, and thus the encryption is not sequential or predetermined.

In one embodiment, the data of the data stream may be encrypted and decrypted based upon the following data transformations and mathematical is operations:

A′=(A+1)modulo 256

B′=(Memory[A]+B+Data[n])modulo 256

Encryption:

CyperText[n]=((Memory[A] XOR Memory[A′])+Memory[B])XOR Data[n]

A′=(A+1)modulo 256,

B′=((((Memory[A] XOR Memory[A′])+Memory[B])XOR CyperText [n])+Memory[A]+B)modulo 256

Decryption:

Data[n]=((Memory[A] XOR Memory[A′])+Memory[B])XOR CyperText[n]

In other embodiments, the encryption may be based upon other transformation operations.

Referring still to FIG. 9, in one embodiment, the encryption process is carried out a number of times equal to the length of the data stream being encrypted. If the encryption has not been carried out to a number of bits equal to the length of the data stream (2070), then the encryption method continues to the next data bits associated via the new values of the first and second counters. Once the encryption has been carried out on a number of data bits equal to the data length of the data stream, the data stream is then encrypted (2080) and is considered secure for transmission. In another embodiment, the final values of the first and second counters are transmitted along with the encrypted data stream to be used with the decryption of the data stream at an end-point device.

In one aspect, the encrypted data stream is then decrypted using the reverse mathematical operations of the encryption method and the final values of the first and second counters as the initialization points for the decryption. In another embodiment, the first and second counters are independently encrypted before transmission.

In the case where the encryption/decryption is based upon the data of the data stream, an initial encryption/decryption key or a seed whereby an initial encryption/decryption key is generated, must be provided. In order to keep the data stream secure, the decryption key may be encrypted via another encryption method, such as, for example, RSA encryption, public key encryption, Diffie-Hellman (D-H) key exchange, or elliptic curve cryptography (ECC).

Block ciphering is a cryptographic technique whereby groups of bits, or blocks, are transformed with a transformation algorithm. The block of data bits is transformed using a transformation key of bits to result in an encrypted (or decrypted) data block of the same number of bits as the original block of bits. Much like with stream ciphering, the greater the number of bits used in the key, the more secure the transformation is. With block ciphering, the transform used to decrypt an encrypted data stream is the inverse of the transform used for encryption.

One additional cryptographic technique that may be implemented in one embodiment is a Vernam cipher, also known as a one-time pad. The Vernam cipher is similar to a stream cipher in that it transforms each individual bit of data. What makes a Vernam cipher unique, and proven to be theoretically secure, is that the keystream used by the Vernam cipher is at least the same data length as the data to be encrypted and the transform for each bit of data is generated completely at random.

In another embodiment, public-key cryptography may be implemented. Also known as asymmetrical cryptography, public-key cryptography uses one key for encryption, and a different key for decryption. Public-key cryptography may use one private key and one public key. In one configuration, public-key encryption may use a public key for encryption of a data stream, and a specific corresponding private key for decryption of the encrypted data stream. Public-key encryption is used for ensuring confidentiality of the contents of the data stream. In another configuration, digital signatures may use a private key for digitally signing a message and the digital signature may be authenticated and verified by use of a corresponding public key. Digital signing is used for authentication purposes. In yet another configuration, RSA public-key cryptography may be used for both encryption/decryption as well as for digital signing. RSA involves three main steps; key generation, encryption, and decryption.

An error detection unit 507 may be used, in one embodiment, for error detection and correction for the data streams received or stored at the microcontroller. Error detection and correction may be used to detect errors in a data stream due to, for example, noise or other impairments encountered during transmission, and further to correct such impairments in the data stream so as to avoid incorrect or incomplete data streams. One example of an error detection and correction scheme is a redundancy check error detection scheme, wherein the data stream is padded with extra data bits at predetermined intervals. These extra data bits are used as check bits, whereby when the padded data stream is received, it is analyzed to determine that the check bits arrive at the same location in the data stream as they were originally inserted. If the check bits in the sent and received data streams do not match, it is determined that an error has occurred during transmission.

A checksum is an example of a redundancy check error detection scheme. In one embodiment, by an arithmetic means, in a checksum the original message bytes are added together and stored, and an extra checksum byte is added to the message as a twos-compliment of the message bytes sum, thus negating the message sum. Later, when the message including the checksum byte is received, another checksum arithmetic is calculated. It is determined that there is no detectable error when the checksum of the received message including the checksum byte is zero. If the checksum is found to not be zero, an error has occurred during transmission. In other aspects, arithmetic means such to as a ones-compliment calculation may be incorporated into a checksum algorithm. In one configuration, an on the fly RFC 1624 computation of the internet checksum via incremental update may be used for the error detection and correction.

Within the scope of the present disclosure, in other embodiments, other is redundancy check functions, such as parity schemes, cyclic redundancy check (CRC), non-cryptographic hash functions, or cryptographic hash functions, may be implemented.

In certain configurations, a circular boundary check 508 may be used for respecting circular or ring buffers in read or in write for data streams.

In another configuration, an RSA coprocessor 509 may be used for encryption/decryption of data streams, or alternatively, the RSA coprocessor 509 may be used for the decryption of an initial key used for a stream ciphering encryption/decryption scheme.

Referring again to FIG. 8, in other embodiments, other system components may include serial ports 510, an inter-integrated circuit (I²C) serial bus 511, a serial peripheral interface (SRI) bus 512, a watchdog circuit 513, one or more clocks 514, an external parallel ports bus 515, and additional input/output connection ports 516. Each of these components may be controlled via the microcontroller's special function registers.

In one embodiment, each device manager 110 (FIG. 1) may be custom programmed for compatibility with one or more corresponding devices 120. The programming for compatibility with the one or more corresponding devices 120 may be in the form of one or more sets of instructions 520 corresponding to communication protocols, security protocols, and/or analysis, filtering, transformation, or conversion of data streams for the one or more specific devices 120. Each of the sets of instructions 520 corresponding to specific devices 120 may be stored as templates for use with other device managers 110 to be used to communicate with other devices of the same design and manufacture specifications. The templates of each custom set of instructions for use with various devices 120 may be stored in a library of known device templates for optimal implementation in future device managers 110. The device managers 110 may be programmed using a high-level programming language, such as the C programming language, BASIC, or Pascal in conjunction with a compiler. In another aspect, the device managers 110 may be programmed directly using assembly programming language without the need for a compiler.

In one configuration, the device manager 110 (FIG. 1) may include a plurality of processors 501. The plurality of processors 501 may each be configured to perform one or more specific tasks of the device manager 110 or the tasks associated with connected devices 120 and subsequent data streams provided by the devices 120. Alternatively, the processors 501 may work in parallel for increased processing power and optimized processing speed for the execution of tasks associated with the device manager 110, such as the sets of instructions 520 corresponding to connection, security, analysis, filtering, transformation, and/or conversion of data streams of connected devices 120.

In another embodiment, the device manager 110 is a software based embedded appliance. Software based device managers 110 may be installed on any existing device or system. The processor 501 of the device manager 110 in a software based embedded appliance may be a virtual processor. The virtual processors of the device manager 110 may be virtual 8051 microcontrollers mounted as software on existing hardware connected to the network 100. The software based device manager 110 may feature a comprehensive operating system and BIOS, and may use the host device or system's input/output network ports for communication with the database server 130. Each virtual machine may have an allocated memory space in the host machine memory.

In other embodiments, other microcontrollers or processors (hardware or virtual) may be used for the processors 501 of the device managers 110 (FIG. 1) of the system. Manufacturers of microcontrollers or processors include, but are not limited to, Applied Micro Circuits Corporation (AMCC), Amtel, Dallas Semiconductor, FreeScale Semiconductor, Fujitsu, Infineon, Intel, National Semiconductor, NEC, Texas Instruments, Toshiba, and Zilog.

In one embodiment, an operating system (OS) incorporated into the to hardware or software device managers 110, may use the entire processing power of a first of a plurality of processors 501 and execute separate applications on the remainder of the processors, which may be running in protected mode. Since the OS uses only the processing power of the first of a plurality of processors 501, the separate applications are each run in parallel on the is separate dedicated protected processors and do not need to use a pre-emptive or cooperative OS to run the specific tasks of the separate applications. This frees up the processing power of the first processor to where the resources of the first processor are not used by the separate applications processors except when one of the separate applications asks for an input/output, TCP/IP, socket, or similar service to be handled.

In another embodiment, the software incorporated into and operating the various components of the network system 100 may be operating system independent, allowing for easy and secure communication between the components.

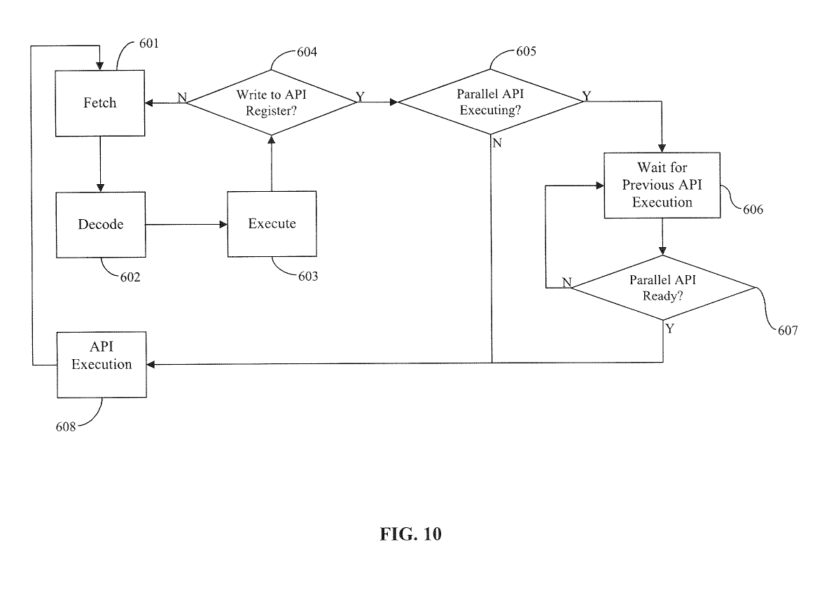

FIG. 10 is a flow chart illustrating the workflow for a processor with application programming interface (API) extensions support in one embodiment. Referring to FIG. 10, standard processor workflow may be broken down into three essential functions: fetching operational programming codes from memory (601), decoding the operational programming codes fetched from memory (602), and executing the fetched and decoded command (603). In one embodiment, the processor 111 of a device manager 110 may be extended using API extensions (604) in the special function registers of the processor 111. In another embodiment, the processor may include dual pointers, thereby allowing for parallel API execution (605-607). The dual pointers may extend the capabilities and power of the processor by extending the code without re-writing the code, thus optimizing the processor power. The API extension code may then be executed (608). API codes that may be supported may include direct memory access (DMA) actions, on the fly checksums, encryption, decryption, arithmetic logic unit (ALU) operations, such as arithmetic operations and logical operations, RSA calculus (for example Chinese Theorem RSA calculus), video driver services, and communication protocol codes.

In one embodiment, a processor may be a 8051 microcontroller utilizing DMA and/or other API's in the microcontroller special function registers. The DMA may allow for the execution of commands by reading and/or writing the system memory independently of the main processor. This optimizes the capabilities of the 8051 microcontroller. In some aspects, 8051 microcontrollers with DMA and other API capabilities may operate with the same or greater efficiency than other processors originally designed for faster computing capabilities that may require more power and/or cost. In another aspect, the lower cost and/or power requirements of an 8051 microcontroller may allow for the inclusion of a plurality of processors to optimize processing capabilities, while simultaneously minimizing manufacturing cost and/or device power requirements.

In other embodiments, DMA and/or other API's may be utilized by a variety of processors depending upon the desired device cost, power consumption, processing capabilities, and/or a number of other features.

In other embodiments, DMA and/or other API's may be implemented to optimize hardware processors or, alternatively, virtual DMA and/or other API programming may be implemented to virtual processors to optimize a virtual configuration.

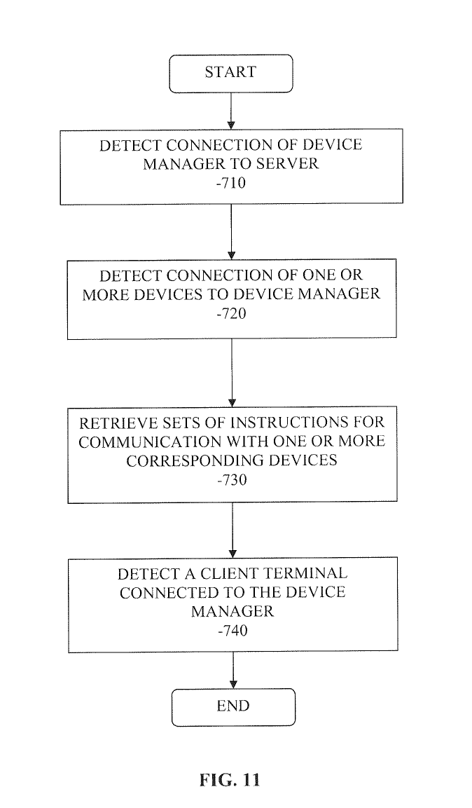

FIG. 11 is a flow chart illustrating steps for initializing a network in one embodiment of the present disclosure. Referring to FIGS. 1 and 11, in one embodiment, a device manager 110 detects connection to a server 130 (710). In one embodiment, the server may be a database server configured to store, among others, sets of instructions, current and/or historical monitored data, current and/or historical analyzed data, or instructions for analysis of data. The device manager 110 includes, among others, an input/output interface 113 for connection to one or more devices 120. The device manager 110 may also detect connection of one or more devices 120 (730). The devices 120 may be monitoring devices whereby the data monitored and gathered by the devices 120 may be transmitted via the device manager 110 for storage on the server 130. Each device manager 110 retrieves one or more sets of instructions, wherein the sets of instructions are configured to provide the necessary protocols for communication between the device manager 110 and the one or more corresponding devices 120 (730). The sets of instructions may be provided as templates stored in a library of configurations for common devices, where the device manager 110 may be configured to retrieve only the sets of instructions corresponding to one or more devices 120 connected to the device manager 110. Each device 120 may utilize various input and output connections and communication protocols, and the corresponding sets of instructions provided to the device manager 110 may be programmed for compatibility with such input and output connections and communication protocols. One or more client terminals may also be detected as connected to the device manager 110 (740) either directly or via a wired or wireless network. In one embodiment, the client terminals may be connected to the device manager 110 via the server 130. In another embodiment, the client terminals may be connected to the device manager via a large-scale network such as the internet. The client terminals, may be configured to monitor, analyze, or transform data sent by the devices 120 and forwarded through the device manager 110 via the communication protocols as configured by the sets of instructions provided to the device manager 110.

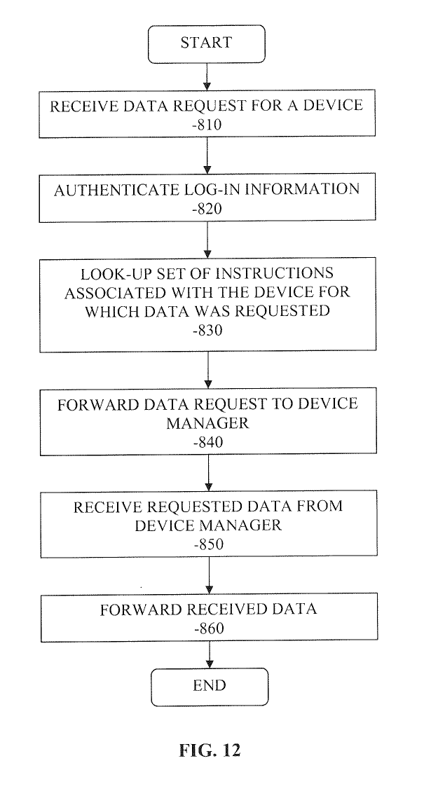

FIG. 12 is a flow chart illustrating steps for monitoring a device in a network system in one embodiment. Referring to FIGS. 1 and 12, in one embodiment, when a technician desires to receive data from a device 120 in the network 100, the technician may first log into the network 100 through a client terminal 140 and places a data request. The database server 130 receives the data request for a specific device 120 from the technician at the client terminal 140 (810). Once the data request is received, before allowing access to the network 100, the log-in information used by the technician at the client terminal 140 is authenticated (820) at the server 130. The server 130 then uses a query protocol to look-up the set of instructions associated with the device 120 from which the technician requested data (830). Once the correct set of instructions has been established and applied to the device manager 110, the data request is forwarded to the device manager 110 from the server 130 through the input/output interface terminals 113 of the device manager 110 associated with the specific device 120 (840). Each set of instructions is configured to interact and communicate with a specific device 120 in the network 100. Each device 120 may be manufactured by a different manufacturer, and thus each device 120 is may have different input and output specifications. By using a device manager 110 with a memory 112 configured to store one or more sets of instructions specifically adjusted for communication with specific devices 120, the various other components of the network 100, such as the client terminal 140 and the database server 130, do not need to include any device specific input/output protocols. Referring back to FIG. 12, once the data from the device 120 is received from the device manager 110 (850), the server 130 forwards the received data to the client terminal 140 (860) for display to the technician.

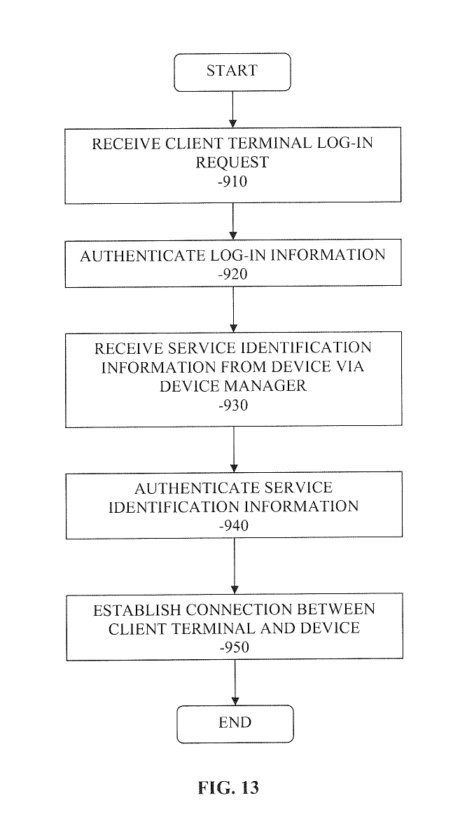

FIG. 13 is a flow chart illustrating steps for establishing a data connection between a client terminal and a device in a network in one embodiment. Referring to FIGS. 1 and 13, in one embodiment, the establishment of a data connection between a device 120 and a client terminal 140 includes steps of user authentication and device verification. The server 130 may first receive a log-in request from a client terminal 140 (910). Log-in information may then be authenticated via, for example, RSA or device signing (920). The server 130 may also receive service identification information (930) from a device manager 110 to which the desired device 120 is connected. The service identification information may then be authenticated (940). Once the device has been authenticated by the verification of the service identification information and the user has been verified by authentication of the user information, a connection between the client terminal 140 and the device 120 via the device manager 110 may be established (950).

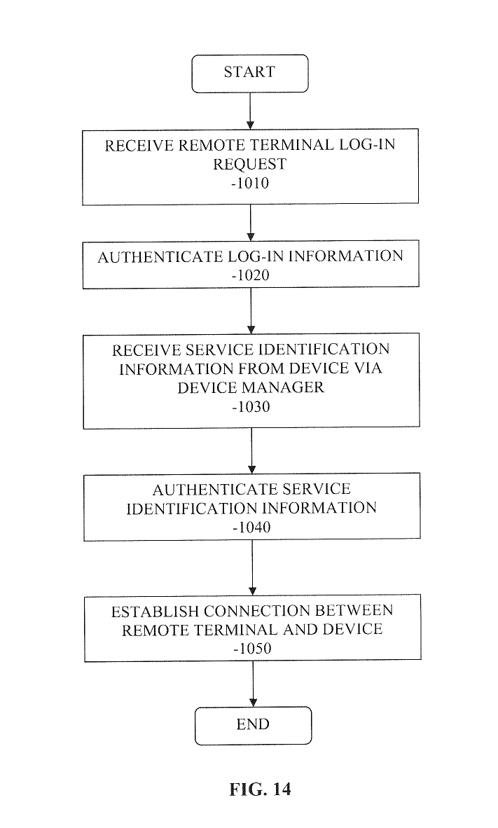

FIG. 14 is a flow chart illustrating steps for establishing a data connection between a remote terminal and a device in a network in one embodiment. Referring to FIGS. 1 and 14, in one embodiment, the establishment of a data connection between a device 120 and a remote terminal 180 includes steps of user authentication and device verification. The server 130 may first receive a log-in request from a remote terminal 180 via a connection medium, such as the internet 170, and a proxy connection routed through a layer 4 router 150 (1010). The layer 4 router 150 may act as a proxy server by use of HTTP/HTTPS proxy or SOCKS proxy protocols. The proxy server acts as a door behind existing network firewalls to allow for external (remote) connection to the server 130. Additional security may be incorporated by use of a gateway 160, whereby the user at the remote terminal 180 must authenticate their user identification before being granted access to the layer 4 router 150 and eventually the network 100. Referring back to FIG. 14, once a log-in request is received from the remote terminal 180, the log-in request may then be authenticated (1020). The server 130 may also receive service identification information (1030) from a device manager 110 to which the desired device 120 is connected. The service identification information may then be authenticated (1040). Once the device has been authenticated by the verification of the service identification information and the user has been verified by authentication of the user information, a connection between the remote terminal 180 and the device 120 via the device manager 110 may be established (1050).

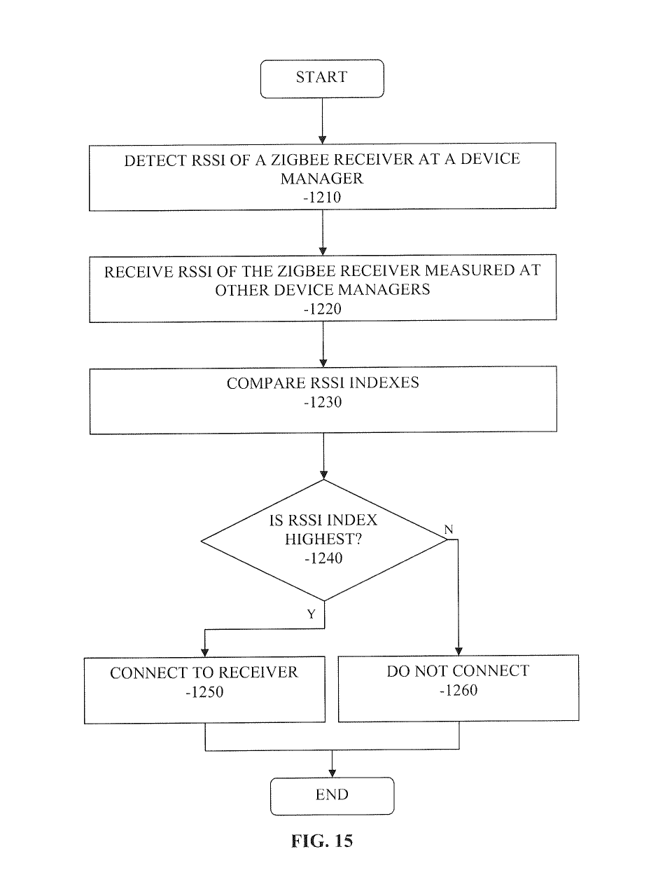

FIG. 15 is a flow chart illustrating steps for automatically connecting a receiver to a device manager in one embodiment. Referring to FIG. 15, in one embodiment, each device manager 110 (FIG. 1) may include a Zigbee antennae and programming configured for Zigbee protocol detection and connection, and the network system 100 may include a Zigbee receiver for gathering data from the devices 120 connected to the device managers 110. The device managers 110 may be configured to determine the relative signal strength index (RSSI) a Zigbee signal of the Zigbee receiver. The RSSI may be determined and calculated using the following formula:

Pᵣ=(Gₜ*Gᵣ*L²)/(4πR)²

where:
Pᵣ=power received (W/m²)
Gₜ=transmitting antenna gain
Gᵣ=receiving antenna gain
L=wavelength
R=distance (between transmitter and receiver)
   The Zigbee receiver may be comprised to use a low strength Zigbee signal, thus reducing signal bouncing which may result in inaccurate signal strength detection.

As the signal strength of the Zigbee receivers are low in power, relatively minor distances of movement may result in a noticeable change in the RSSI value of the signal. As such, when the Zigbee receiver is moved toward the device manager 110 to which connection is desired, the RSSI value will increase.

Referring back to FIG. 15, a device manager 110 (FIG. 1) may detect the RSSI of a Zigbee receiver (1210) and also receive RSSI values detected at other device managers within range (1220). The RSSI values of the device managers are then compared (1230) to determine which RSSI value detected is the greatest (1240). If the RSSI value at the device manager 110 is determined to be highest, the device manager 110 may automatically connect to the Zigbee receiver (1250) for transfer of data from the devices 120 connected to the device manager 110. If the RSSI value at the device manager 110 is determined to not be the highest, the device manager 110 will not connect to the Zigbee receiver.

In another embodiment, when the RSSI value at the device manager 110 is determined to be the highest, the device manager 110 may still not connect to the Zigbee receiver, but alternatively, may be moved to the top of a list of available device managers 110 for connection, thus allowing a technician using the Zigbee receiver to more easily choose the desired device manager 110 in which to connect.

In another embodiment, the device manager 110 determined to be the desired device manager 110 for connection may be determined based upon the rate of change of the compared RSSI values measured by the device managers. To this end, it may be determined that the Zigbee receiver should connect to the device manager 110 determined to have the highest rate of change of RSSI detected by the device managers, thus indicating the Zigbee receiver to be moving in the direction toward the desired device manager 110. The movement toward the device manager may be a linear movement directly toward the device manager 110, or may be detected based upon a radial movement, whereby the direction of the Zigbee signal originating at the Zigbee receiver is determined to be oriented as moving toward the desired device manager 110.

In other embodiments, the measurement of the RSSI values may be used to determine proximity, location, vector of movement, or a combination thereof of devices employing Zigbee receivers and/or transmitters.

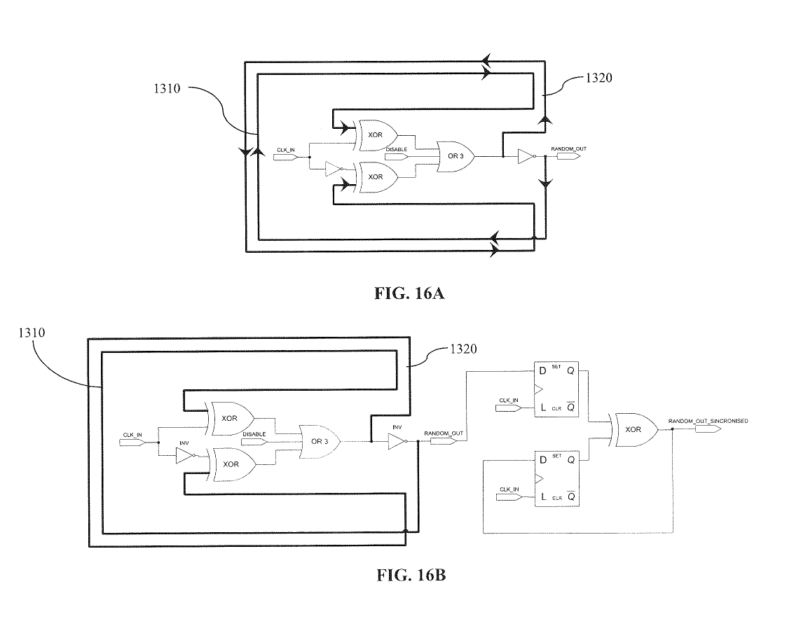

In another embodiment, additional security features may be incorporated, such as a random number generating device used for security codes to authenticate a user at a terminal. FIGS. 16A and 16B are block diagrams illustrating a random number generating device using quantum states of an FPGA for use in one or more embodiments of the present disclosure. Referring to FIG. 16A, a random bit generation may be made without a seed value based on the solid state of an FPGA. The FPGA may include two data paths 1310, 1320 of substantially equal distance or propagation time in opposite directions and the XOR, 3-OR, INV logic configuration shown in FIG. 16A to determine the state of the circuit. The two data paths 1310, 1320 may be distributed around the FPGA in such a manner as to suffer from thermal noise that will introduce additional random signal propagation time while the loop is oscillating. In one aspect, the two data paths 1310, 1320 may be within 95% and 98% in length or propagation time of one another. The oscillation resulting from the logic configuration of FIG. 16A is a random oscillation, and thus a random bit may be determined by determining the state of the machine.

Referring to FIG. 16B, in one embodiment, as shown in FIG. 16B, a standard XOR combined with a self referenced latch may be used on each random bit output from the FPGA described above to produce an even more random bit.

In other embodiments, other integrated circuits or ASICs may be implemented in lieu of the FPGA for the random number generator.

Multiple random bits may be produced at the same time at the same clock cycle, such as 1 byte or 1 word length (8 or 16 bits). These blocks of random bits may be used as an iteration for determination of a random number which may be is used for security for the network system. Each random bit may be produced using multiple pairs of data paths located on the same circuit, or may be produced using pairs of data paths each located on separate circuits, or may be produced using a combination of multiple pairs of data paths located on multiple circuits.

In another embodiment, the circuits of the random bit generator may be incorporated into a housing, upon which may be a display configured to output the random bits or sets of multiple random bits which may be displayed as numbers, letters, symbols, characters, or a combination thereof.

In another embodiment, a random number generator may be incorporated into a security device. The security device may be used as a means for confirming the presence of an authorized user for access to a remote or local terminal of a network. The security device may be a small electronic device configured to be coupled to a computer terminal via, for example, a USB connection, and randomly generate a number. The randomly generated number may be displayed on a display of the security device. The security device many further include programming configured to request input via a keyboard or other character input device of the computer terminal. The keyboard may be used to input the generated random number displayed on the security device for comparison. The computer terminal may receive the random number generated by the security device and compare the generated random number to the number inputted by the user via the keyboard. If the inputted number matches the received random number, the user is verified as authorized and access to the computer terminal may be granted.

In another aspect, the security device may further include programming for additional security, such as a pre-programmed password requirement. In such an aspect, in addition to the requirement of the verified input of a generated random number, a pre-programmed password may also be required to be entered and verified before access to the computer terminal is granted. In another aspect, in addition to a pre-programmed password, the security device may further include programming for the requirement of a user-name linked to the pre-programmed password. Such security measures may ensure not only the physical presence of the security device, but also that the security device is in the possession of an authorized user. In another aspect, the security device may further include programming for encryption and/or decryption of data streams received at the computer terminal.

In one embodiment, the random number generator is a quantum state random number generator, whereby one or more pairs of data paths with logic configurations are used to generate one or more random bits, which may be used to generate a random number. In other embodiments, the random bits may be used to generate a string of characters.

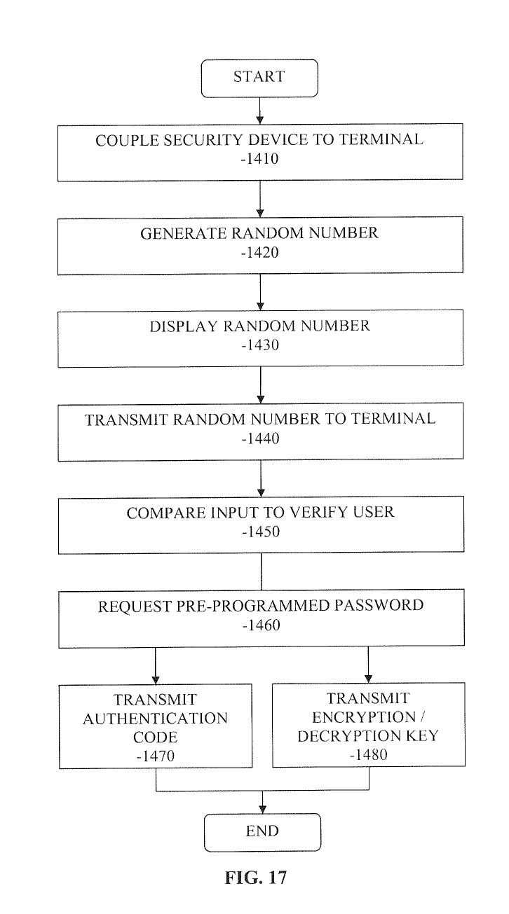

FIG. 17 is a flow chart illustrating steps for verifying a user at a computer terminal. Referring to FIG. 17, in one embodiment, a security device is coupled to a computer terminal port (1410), such as a USB port. Upon connection to the computer terminal, the security device generates a random number (1420) by determining the quantum state of one or more pairs of data paths. The generated random number is displayed on a display of the security device (1430) for a user to view and input into the computer terminal via a keyboard. The security device additionally transmits a signal to the computer terminal identifying the generated random number (1440) so that the computer terminal may compare the number inputted via the keyboard to the random number generated by the security device. If the two numbers coincide, then the user is verified (1450).

Referring still to FIG. 17, in a further aspect, the security device may also request via the computer terminal a pre-programmed password be entered by the user (1460) to verify their identity. In an additional further aspect, once a user is verified, the security device may transmit an authentication code to the to computer terminal (1470) and/or may transmit an encryption/decryption key (1480) to the computer terminal for encryption and/or decryption of data streams transmitted and/or received at the computer terminal.

In one embodiment, the security device may be configured for connection to a computer terminal via an interface such as USB. In other embodiments, the is security device may be configured for connection to a computer terminal via other interfaces, such as parallel connection, serial connection, FireWire connection, Ethernet connection, or various other connection types. In other embodiments, the security device may be configured for connection to devices other than a computer terminal, such as remote devices, personal data assistants (PDAs), memory devices, smart phones, or the like.

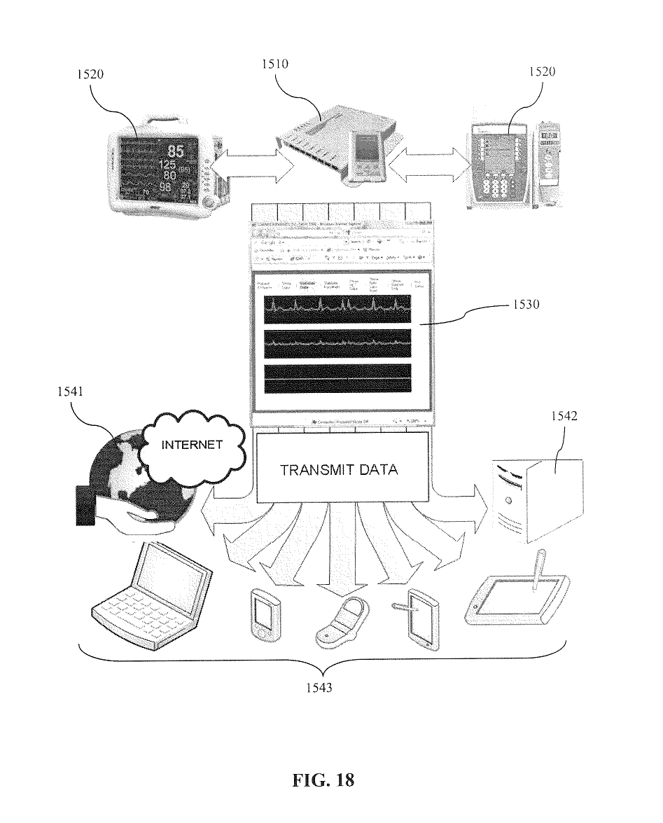

FIG. 18 illustrates a method of transferring data over a network in one embodiment of the present disclosure. Referring to FIG. 18, in one embodiment, a device manager 1510, such as the device managers as described above, is in operational communication with one or more network devices 1520. The network devices 1520, in one embodiment, are configured for operations such as, among others, monitoring, measuring, mechanical operation, displaying, or combinations thereof. In one aspect, the network devices 1520 are not initially configured for network communication. Data 1530 associated with the network devices 1520 is monitored by the device manager 1510 via wired network protocols, wireless network protocols, power monitoring (by, for example, voltage or current monitoring), ambient conditions measurements (such as temperature or other physical conditions monitoring) or through the use of third party measurement devices, such as standard or infrared cameras, or a combination thereof. Communication protocols and methods may include, but are not limited to wired or wireless communication such as WiFi, 802.11x, RF, Bluetooth, Zigbee, USB, Wireless USB, Firewire, Ethernet, RS-232, RS-422, or RS-485 serial interfaces, and the like. Data 1530 associated with the network devices 1520 may be in the form of graphical data, electronic signals data, numerical data, audio data, video data, waveforms, analog values representing physical measurements, or a combination thereof. In one embodiment, data 1530 may correspond to, for example, human physical data (such as electrocardiography (EKG) heart data, blood pressure readings, blood sugar readings, oxygen saturation (SpO2) data, Electroencephalography (EEG) brain activity, drug concentration information, etc.), ambient data readings (such as earthquake monitoring data, ambient temperature and pressure readings, etc.), gas concentrations (such as radon, oxygen, carbon dioxide, etc.), or a combination thereof.

Referring still to FIG. 18, the device manager 1510 is also in operational communication with one or more client terminals 1543, networks 1541, such as the internet, servers 1542, or combinations thereof. Data 1530 associated with the network devices 1520 that is monitored by the device manager 1510 is forwarded to one or more of the client terminals 1543, networks 1542, and servers 1542. In one embodiment, the data 1530 is forwarded to a server 1542 for distribution across a network to one or more client terminals 1543. In this embodiment, the data 1530 received at the server 1542 may be stored in a database as historical data and/or may be further forwarded to client terminals 1543 for viewing, monitoring, and/or adjustment by a user. The client terminals 1543 may be in communication with the server 1542 directly via wired or wireless connection protocols, or may be in communication with the server 1542 through a network, either a local network or intranet, or via a network such as the internet.

In another embodiment, the device manager 1510 is configured as part of an ad-hoc network. In such a configuration, the device manager 1510 may be configured to forward data directly to one or more client terminals 1543. Client terminals 1543, in one embodiment, may be devices including, but not limited to, computers, laptop computers, personal digital assistants (PDAs), cellular phones, smart phones, tablets, and the like. Direct communication between the device manager 1510 and the client terminals 1543, in one aspect, may reduce lag time associated with transmitting data 1530 to the client terminals 1543. For example, data transmitted from the device manager 1510 to a client terminal 1543 through a server 1542, may experience lag time as the data is stored on the server 1542 prior to transmission to the client terminal 1543. As such, data 1530 associated with the network devices 1520 may be transmitted in substantially real-time to a client terminal 1543.

In yet another embodiment, the device manager 1510 is configured to transmit data 1530, such as real-time or substantially real-time waveforms, simultaneously or substantially simultaneously to more than one end locations, for example, to a client terminal 1543 and a server 1542. In such a configuration, data 1530 associated with network devices 1520 may be transmitted to a client terminal 1543 for real-time monitoring by a user, while simultaneously being transmitted to a server 1542 for storage as historical data. In another configuration, the data 1530 may be transmitted to a plurality of client terminals 1530 simultaneously in substantially real-time for monitoring by more than one user.

Referring still to FIG. 18, data 1530 forwarded by the device manager 1510 may be provided to client terminals 1543 in a variety of formats. The chosen format may be determined by the device manager 1510 based upon configuration communication between the device manager 1510 and the client terminal 1543. In one aspect, the device manager 1510 may be configured to detect the types of formats the client terminal 1543 is configured to accept. Such format types include, but are not limited to text, numerical lists, XML, HTML, Java Architecture for XML Binding (JAXB), images (such as jpeg, gif, or png), video (such as avi, mpeg, wmv, or mkv), portable document format (PDF), numerical database, or a combination thereof. In another embodiment, the device manager 1510 and network system may be configured with security protocols. For example, data 1530 associated with the network devices 1520 may be encrypted by the device manager 1510 before transmission to a client terminal 1543 or server 1542. Furthermore, the client terminal 1543 or server 1542 may be configured to decrypt the encrypted received data. In another aspect, security may be implemented to validate operational connection between the network devices 1520, device manager 1510, server 1542, and/or client terminals 1543.

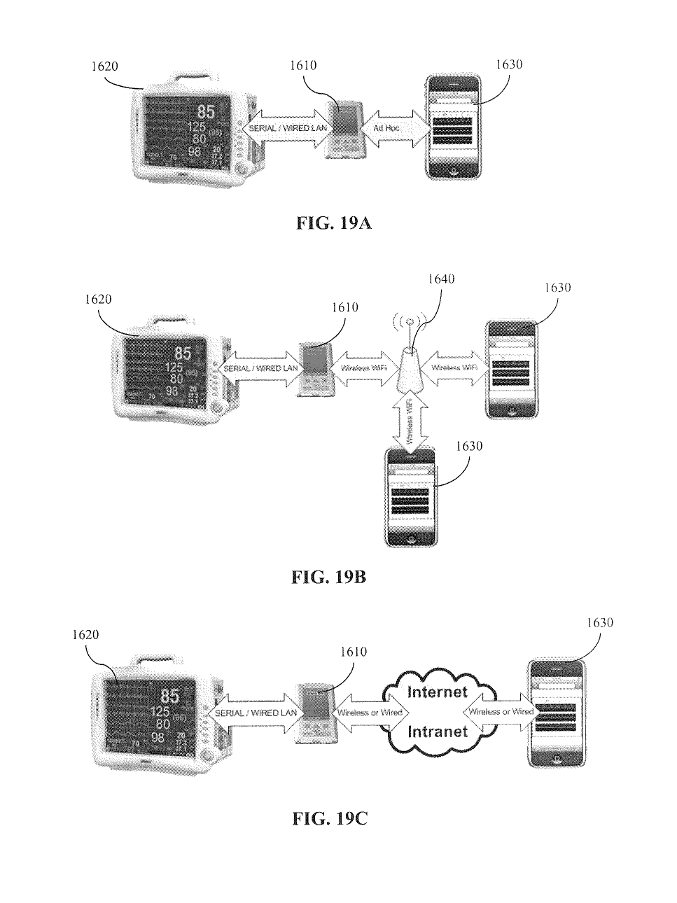

FIGS. 19A, 19B, and 19C illustrate methods of transferring data between a network device and one or more client terminals. Referring to the Figures, a device manager 1610 is in operative communication with one or more network devices 1620 and one or more client terminals 1630. The device manager 1610 is in operative communication with the network device 1620 via one-way or bi-directional communication. The communication may be a wired or wireless connection utilizing a variety of protocols, including wired serial communication (RS-232, RS-422, RS-485 for example), wired parallel communication, USB, Wireless USB, FireWire, Ethernet, RF, WiFi, 802.11x, Bluetooth, Zigbee, or the like.

In one embodiment, as illustrated in FIG. 19A, communication between the device manager 1610 and the client terminal 1630 may be direct communication via wired or wireless communication. In one aspect, the communication between the device manager 1610 and the client terminal 1630 is via an ad-hoc wireless configuration, wherein data is transferred directly from the device manager 1610 to the client terminal 1630.

In another embodiment, as illustrated in FIG. 19B, communication between the device manager 1610 and the client terminal 1630 may be direct communication via a wireless network infrastructure 1640. In such a configuration, the device manager 1610 and client terminals 1630 are all connected to a wireless infrastructure network 1640, and data received from the network device 1620 by the device manager 1610 is transmitted across the wireless network 1640 and received by the client terminals 1630.

In yet another embodiment, as illustrated in FIG. 19C, communication between the device manager 1610 and the client terminal 1630 may be a remote connection. In such a configuration, the client terminal 1630 is configured to connect to the device manager 1610 via a remote connection over a local intranet or a public network, such as the Internet. In one aspect, the connection between the client terminal 1630 and the device manager 1610 is made via a web browser.

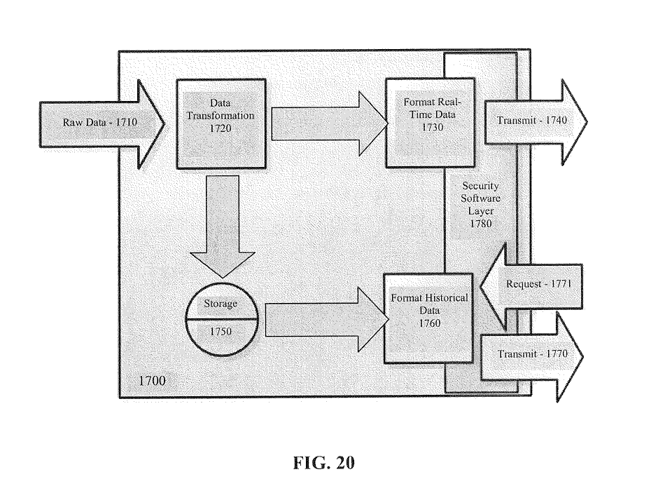

FIG. 20 is a flow chart illustrating a system for forwarding data from a network device in one embodiment. Referring to FIG. 20, raw data is received at a device manager 1700 from a network device 1710. Data is transmitted from the network device to the device manager 1700 via wired or wireless connection protocols, including wired serial connection (RS-232, RS-422, RS-485 for example), wired parallel connection, Ethernet, USB, Wireless USB, FireWire, power connection, WiFi, 802.11x, Bluetooth, Zigbee, and the like.

In one embodiment, the device manager 1700 is configured to receive data from one or more specific network devices. The raw data received at the device manager 1700 is transformed into usable data 1720 based upon the type of device connected to the device manager 1700 and the corresponding configuration of the device manager. Once the raw data is transformed into usable data by the device manager, the usable data may then be formatted into a desired format 1730 for transmitting and subsequent output at a client terminal. Once formatted into output data, the data is then transmitted 1740 to a client terminal for monitoring by a user. The output data may be in the form of web page (ie HTML format) data, graphical data, electronic signals data, numerical data, audio data, video data, waveforms or a combination thereof. In one embodiment, the output data is transmitted directly from the device manager 1700 to a client terminal, wherein the output data is also substantially real-time data.

Furthermore, in one embodiment, the transformed raw data may be stored locally 1750, in addition to, or in lieu of, transmitting the data directly to a client terminal. Data stored locally in the device manager 1700 may be stored as historical data and formatted 1760 for transmission to a server or other external memory device. In one embodiment, historical data is transmitted to a server 1770 continuously or periodically, or alternatively, historical data is only transmitted to a server after the device manager receives a request for historical data 1771.

In another embodiment, the device manager 1700 also includes a layer of security software 1780. Security may include an encryption and/or decryption algorithm for use in transmission and/or reception of data. Furthermore, security may include programming configured for authentication of a client terminal and/or a server. In this configuration, one-way or bi-directional communication between the device manager 1700 and client terminals and/or servers is only established after authentication of the client terminal or server by the device manager 1700.

In one embodiment, a method for networking devices may comprise detecting a plurality of network devices, including a first network device and a is second network device, connected to a network, determining a first communication protocol associated with the first network device based on a first network device profile, querying a database for a first configuration profile associated with the first network device profile, retrieving the first configuration profile, storing the first configuration profile, executing the stored first configuration profile for configuring a first terminal of a network communication interface for communication with the first network device using the first configuration profile, determining a second communication protocol associated with the second network device based on a second network device profile, querying a database for a second configuration profile associated with the second network device profile, retrieving the second configuration profile, storing the second configuration profile, executing the stored second configuration profile for configuring a second terminal of the network communication interface for communication with the second network device using the second configuration protocol, simultaneously receiving data from the first network device based on the first communication protocol and the second network device based on the second communication protocol, wherein the first communication protocol and the second communication protocol are different, and communicating the received data from the first network device and the second network device, wherein communicating the received data from the first network device and the second network device comprises encrypting the received data from the first network device and the second network device using a stream cipher encryption scheme, wherein the stream cipher encryption scheme is dependent upon the received data from the first network device and the second network device.

The first communication protocol and the second communication protocol may be selected from the group comprising hypertext transfer protocol (HTTP), file transfer protocol (FTP), internet protocol suite (TCP/IP), open systems interconnection (OSI), universal plug and play (UPnP), internet SCSI (iSCSI), network file systems protocol, simple object access protocol (SOAP), or a combination thereof.

The first terminal and the second terminal of the network communication is interface may be selected from the group comprising unidirectional or bidirectional Ethernet/local area network (LAN), wireless local area network (WLAN), universal serial bus (USB), Wireless USB, parallel interface, RS-232, RS-422, or RS-485 serial interfaces, FireWire, universal asynchronous receiver/transmitter (UART), small computer system interface (SCSI), WiFi, Zigbee, Bluetooth, radio frequency (RF), infrared (IR), fiber optic, high-definition multimedia interface (HDMI), S-video, RCA connector, TRS connector, coaxial cable, or a combination thereof.

The plurality of networked devices may be eight devices.

The plurality of networked devices may be thirty-two devices.

The plurality of networked devices may be 128 devices.

In one aspect, the method may further comprise monitoring, analyzing, filtering, converting, and/or transforming data streams received from the plurality of network devices.

In yet another aspect, the method may further comprise retrieving the data streams at an interface terminal.

The method may further comprise decrypting the retrieved data streams.

The interface terminal may be a local terminal.

The interface terminal may be portable.

The interface terminal may be a remote terminal.

The remote terminal may retrieve the data streams through a routing device.

The routing device may be configured for firewall avoidance.

In one aspect, firewall avoidance may be achieved through one or more protocols selected from the group consisting of reverse transmission control protocol (TCP) connections, hypertext transfer protocol (HTTP) proxies, hypertext transfer protocol over secure socket layer (HTTPS) proxies, SOCKS protocols, or a combination thereof.

Communicating the received data from the first network device and the second network device may further comprise compressing the data stream using a compression scheme, wherein the compression scheme detects one or more repeating data segments of the data received from the first network device and the second network device and replaces the repeating data segments with data bits corresponding to the data of the replaced data segments.

In one embodiment, a device manager may comprise a control unit, a network communication interface coupled to the control unit, and a memory for storing instructions which, when executed by the control unit, causes the control unit to detect a plurality of network devices, including a first network device and a second network device, connected to a network, determine a first communication protocol associated with the first network device based on a first network device profile, query a database for a first configuration profile associated with the first network device profile, retrieve the first configuration profile, store the first configuration profile, execute the stored first configuration profile for configuring a first terminal of the network communication interface for communication with the first network device using the first configuration profile, determine a second communication protocol associated with the second network device based on a second network device profile, query a database for a second configuration profile associated with the second network device profile, retrieve the second configuration profile, store the second configuration profile, execute the stored second configuration profile for configuring a second terminal of the network communication interface for communication with the second network device using the second configuration profile, simultaneously receive data from the first network device based on the first communication protocol and the second network device based on the second communication protocol, wherein the first communication protocol and the second communication protocol are different and communicate the received data from the first network device and the second network device, wherein the instructions for communicating the received data from the first network device and the second network device comprises instructions for encrypting the received data from the first network device and the second network device using a stream cipher encryption scheme, wherein the stream cipher encryption scheme is dependent upon the received data from the first network device and the second network device.

The first communication protocol and the second communication protocol may be selected from the group comprising hypertext transfer protocol (HTTP), file transfer protocol (FTP), internet protocol suite (TCP/IP), open systems interconnection (051), universal plug and play (UPnP), internet SCSI (iSCSI), network file systems protocol, simple object access protocol (SOAP), or a combination thereof.

The first terminal and the second terminal of the network communication interface may be selected from the group comprising unidirectional or bidirectional Ethernet/local area network (LAN), wireless local area network (WLAN), universal serial bus (USB), Wireless USB, parallel interface, RS-232, RS-485, or RS-422 serial interfaces, FireWire, universal asynchronous receiver/transmitter (UART), small computer system interface (SCSI), WiFi, Zigbee, Bluetooth, radio frequency (RF), infrared (IR), fiber optic, high-definition multimedia interface (HDMI), S-video, RCA connector, TRS connector, coaxial cable, or a combination thereof.

The plurality of networked devices may be eight devices.

The plurality of networked devices may be thirty-two devices.

The plurality of networked devices may be 128 devices.

One aspect may further comprise instructions which, when executed by the control unit, may cause the control unit to monitor, analyze, filter, convert, and/or transform data streams received from the plurality of network devices.

In one aspect, the device manager may further comprise an encryption/decryption unit.

In one aspect, the device manager may further comprise an error detection unit.

In one aspect, the device manager may further comprise a housing.

The housing may be one rack unit in height.

The housing may be a half rack unit in width.

The device manager may be portable.

Instructions for communicating the received data from the first network device and the second network device may further comprise instructions for compressing the data stream using a compression scheme, wherein the compression scheme detects one or more repeating data segments of the data received from the first network device and the second network device and replaces the repeating data segments with data bits corresponding to the data of the replaced data segments.

In one aspect, the control unit may comprise application programming interface routines available in special function registers of the control unit.

In another aspect, the control unit may comprise dual pointers configured to reference the special function registers of the control unit.

The application programming interface routines may be configured to support execution, by the control unit, of instructions for checksums, encryption, decryption, arithmetic operations, logical operations, RSA cryptography calculus, video driver services, communication protocols, or a combination thereof.

In one embodiment, a network system may comprise a memory unit, a database stored in the memory unit, one or more device managers coupled to the memory unit, the device managers comprising, a control unit, a network communication interface coupled to the control unit, and a memory for storing instructions which, when executed by the control unit, causes the control unit to, detect a plurality of network devices, including a first network device and a second network device, connected to a network, determine a first communication protocol associated with the first network device based on a first network device profile, query a database for a first configuration profile associated with the first network device profile, retrieve the first configuration profile, store the first configuration profile, execute the stored first configuration profile for configuring a first terminal of the network communication interface for communication with the first network device using the first configuration profile, determine a second communication protocol associated with the second network device based on a second network device profile, query a database for a second configuration profile associated with the second network device profile, retrieve the second configuration profile, store the second configuration profile, execute the stored second configuration profile for configuring a second terminal of the network is communication interface for communication with the second network device using the second configuration profile, simultaneously receive data from the first network device based on the first communication protocol and the second network device based on the second communication protocol, wherein the first communication protocol and the second communication protocol are different, and communicate the received data from the first network device and the second network device, wherein the instructions for communicating the received data from the first network device and the second network device comprises instructions for encrypting the received data from the first network device and the second network device using a stream cipher encryption scheme, wherein the stream cipher encryption scheme is dependent upon the received data from the first network device and the second network device.

The first communication protocol and the second communication protocol may be selected from the group comprising hypertext transfer protocol (HTTP), file transfer protocol (FTP), internet protocol suite (TCP/IP), open systems interconnection (OSI), universal plug and play (UPnP), internet SCSI (iSCSI), network file systems protocol, simple object access protocol (SOAP), or a combination thereof.

The first terminal and the second terminal of the network communication interface may be selected from the group comprising unidirectional or bidirectional Ethernet/local area network (LAN), wireless local area network (WLAN), universal serial bus (USB), Wireless USB, parallel interface, RS-232, RS-485, or RS-422 serial interfaces, FireWire, universal asynchronous receiver/transmitter (UART), small computer system interface (SCSI), WiFi, Zigbee, Bluetooth, radio frequency (RF), infrared (IR), fiber optic, high-definition multimedia interface (HDMI), S-video, RCA connector, TRS connector, coaxial cable, or a combination thereof.

The plurality of networked devices may be eight devices.

The plurality of networked devices may be thirty-two devices.

The plurality of networked devices may be 128 devices.

Instructions for communicating the received data from the first network device and the second network device may further comprise instructions for compressing the data stream using a compression scheme, wherein the compression scheme detects one or more repeating data segments of the data received from the first network device and the second network device and replaces the repeating data segments with data bits corresponding to the data of the replaced data segments.

In one aspect, the control unit may comprise application programming interface routines available in special function registers of the control unit.

In another aspect, the control unit may comprise dual pointers configured to reference the special function registers of the control unit.

The application programming interface routines may be configured to support execution, by the control unit, of instructions for checksums, encryption, decryption, arithmetic operations, logical operations, RSA cryptography calculus, video driver services, communication protocols, or a combination thereof.

In one aspect, the device managers of the network system may further comprise instructions which, when executed by the control unit, may cause the control unit to monitor, analyze, filter, convert, and/or transform data streams received from the plurality of network devices.

The network system may further comprise an interface terminal coupled to the device manager configured to retrieve the data streams received from the plurality of network devices.

The interface terminal of the network system may be further configured to decrypt the retrieved data streams.

The interface terminal may be a local terminal.

The interface terminal may be portable.

The portable interface terminal may be configured for Zigbee communication protocols.

The one or more device managers may be configured for Zigbee communication protocols.

In one aspect, the network system may comprise two or more device is managers.

The two or more device managers may be configured to detect the relative signal strength index of the portable interface terminal configured for Zigbee communication protocols at the device manager.

The device managers may be configured to compare the detected relative signal strength index values of the two or more device managers.

The portable interface terminal may be configured to communicate with the device manager with the highest relative signal strength index value.

The portable interface terminal may include a listing of device managers within communication range of the portable interface terminal.

The portable interface terminal may be configured to put the device manager with the highest relative signal strength index value at the top of the listing of device managers within communication range of the portable interface terminal.

The interface terminal may be a remote terminal.

The network system may further comprise a routing device coupled to the one or more device managers.

The remote terminal may be coupled to the one or more device managers through the routing device.

The routing device may be configured for firewall avoidance.

Firewall avoidance may be achieved through one or more protocols selected from the group consisting of reverse transmission control protocol (TCP) connections, hypertext transfer protocol (HTTP) proxies, hypertext transfer protocol over secure socket layer (HTTPS) proxies, SOCKS protocols, or a combination thereof.

The network system may further comprise a gateway coupled to the routing device.

The remote terminal may comprise a web browser, and the remote terminal may be coupled to the network via a web portal.

Information displayed on the web browser may be displayed as cascading style sheets (CSS), asynchronous JavaScript and XML (AJAX), extensible is stylesheet language (XSL), document style semantics and specification language (DSSSL), JavaScript style sheets (JSSS), or a combination thereof.

Display settings of the information displayed on the web browser may be customized by the user.

The customized display settings of the information displayed on the web browser may be stored on the memory unit.

The customized display settings of the information displayed on the web browser stored on the memory unit may be updated via a direct XSL to XML transformation.

The network system may further comprise a certificate authority adapted for verification of a user's identity before the user is granted access to the plurality of networked devices via the interface terminal.

The certificate authority may use a public key infrastructure scheme to bind a public key with a user's identity for verification of the user's identity.

The certificate authority may use an RSA cryptography scheme for verification of the user's identity.

The network system may further comprise a data recording module.

The data recording module may be configured for recording session and event logs.

In one aspect, the memory unit may be a server.

The server may be a database server.

The database server may be a relational database server.

In another embodiment, a random bit generator may comprise a first data path loop of a circuit flowing in a first direction, and a second data path of the circuit flowing in a second direction, wherein the second direction is opposite the first direction, wherein the first data path and the second data path are of to substantially the same length, wherein the first data path and the second data path are distributed across the circuit such that thermal noise introduced during the oscillating loop of the first data path and second data path introduces random additional signal propagation time, and wherein data logic of the circuit outputs a high or a low data bit based upon a comparison of the propagation times of the first data path and the second data path.

The circuit may be a field-programmable gate array.

The circuit may an application specific integrated circuit.

In another embodiment, a random number generator may comprise a plurality of random bit generators used in parallel, wherein the random bit outputs of the plurality of random bit generators are combined to produce a random number.

The first data path loop and the second data path loop of the plurality of random bit generators may be located on the same circuit.

Each random bit generator may comprise a separate circuit.

In one aspect, the random number generator may comprise a housing.

In another aspect, a display may be coupled to the housing.

In another embodiment, a security device may comprising, a housing, a random bit generator comprising one or more circuits located within the housing, configured to generate one or more random bits, a connection interface coupled to the random bit generator, and a display coupled to the random bit generator and situated on the housing and configured to display the one or more random bits generated by the random bit generator.

The random bit generator may generate one or more random bits based upon the quantum state of one or more circuits.

The random bit generator may generate a random bit by comparing the propagation time of a first data path on one of the one or more circuits to a second data path on the same circuit as the first data path, wherein the first data path and the second data path are substantially the same length.

The lengths of the first data path and the second data path may be between 95% and 98% of each other.

The first data path and second data path may be distributed across the circuit so as to allow noise in the data paths.

The difference in propagation time may be due to noise in the first data path and the second data path.

The first data path and the second data path may be connected to a logic circuit designed to output a “1” bit or a “0” bit based upon the comparison of the propagation times of the first data path and the second data path.

The random bit generator may be configured to generate a plurality of random bits substantially simultaneously at one clock cycle.

The plurality of random bits may comprise one byte.

The plurality of random bits may comprise eight bits.

The plurality of random bits may comprise sixteen bits.

The plurality of random bits may correspond to a character.

The plurality of random bits may correspond to a number.

In one aspect, each of the plurality of random bits may be generated by comparing the propagation time of a first data path on one of the one or more circuits to a second data path on the same circuit as the first data path, wherein the first data path and the second data path are substantially the same length.

The first and second data paths for each of the generated random bits may be located on the same circuit.

The first and second data paths for each of the generated random bits may be located on different circuits.

The first and second data paths for each of the generated random bits may be located on a combination of the same circuits and different circuits.

The one or more circuits may be field-programmable gate arrays (FPGAs).

The one or more circuits may be integrated circuits.

The integrated circuits may be application specific integrated circuits (ASICs).

The connection interface may be a universal serial bus (USB) interface.

The USB interface may be a mini-USB interface.

The connection interface may be an Ethernet interface.

The connection interface may be a IEEE 1394 connection interface.

The IEEE 3194 connection interface may be a FireWire connection interface.

The connection interface may be a wireless connection interface.

The wireless connection interface may be a wireless universal serial bus (Wireless USB) interface.

The wireless connection interface may be a WiFi connection interface.

The wireless connection interface may be a Bluetooth connection interface.

The wireless connection interface may be a Zigbee connection interface.

The wireless connection interface may be a radio frequency (RF) connection interface.

The display may be a seven-segment display.

The display may comprise a plurality of seven-segment displays.

The display may be a light-emitting diode (LED) display.

The display may be a dot-matrix display.

The display may be a liquid crystal display (LCD).

The display may be a plasma display.

The random bit generator may be configured to generate one or more random bits when the security device is coupled to a computing device via the connection interface.

In one embodiment, the security device may further comprise a memory.

The memory may store instructions which, when executed by a processor, causes a computing device coupled to the security device via the connection interface to request input of the one or more random bits generated by the random bit generator as displayed on the display.

The memory may store instructions which, when executed by the processor, causes the computing device to receive a data packet containing the generated one or more random bits.

The memory may store instructions which, when executed by the processor, causes the computing device to compare the inputted one or more random bits to the received one or more random bits.

The memory may store a password.

The memory may store instructions which, when executed by the processor, causes the computing device to request input of the password.

The memory may store instructions which, when executed by the processor, causes the computing device to compare the inputted password to the stored password.

The security device may be validated when the inputted one or more random bits are the same as the received one or more random bits and the inputted password is the same as the stored password.

The memory may store an authentication code configured to allow user access to the computing device, and wherein the authentication code is transmitted to the computing device when the security device is validated.

The memory may store an encryption/decryption key, and wherein the encryption/decryption key is transmitted to the computing device when the security device is validated.

In one embodiment, a method for updating a database may comprise, providing a web portal, displaying database information as an XSL form via the web portal, editing the XSL form via the web portal, and reconstructing the XML database based upon the edits to the XSL form, wherein reconstructing the XML database comprises directly transforming the XSL form data edits into the XML database.

The web portal may be a web browser.

The web browser may be an HTML web page.

The XSL form may be displayed in the HTML web page.

In yet another embodiment, a device manager may comprise, one or more processors, a communication interface coupled to the one or more processors, and a memory for storing instructions which, when executed by the one or more processors, causes the one or more processors to, detect one or more devices connected to the communication interface, determine a device type associated with each of the one or more devices, receive data from the one or more devices, encrypt the data received from the one or more devices, and transmit the encrypted data to a network data storage device configured for accessibility by one or more remote terminals.

The one or more processors may include application programming interface (API) extensions.

The API extensions may include direct memory access extensions.

The one or more processors may be 8051 microcontrollers.

The one or more processors may include direct memory access extensions.

The memory for storing instructions which, when executed by the one or more processors, may cause the one or more processors to detect one or more devices connected to the communication interface, wherein the one or more devices are legacy devices not initially configured for network communication.

The data received from the one or more legacy devices may be power consumption data.

The memory for storing instructions which, when executed by the one or more processors, may cause the one or more processors to convert the power consumption data into device function data.

In one aspect, converting the power consumption data into device function data may be achieved through the use an algorithm specific to the device type associated with the device.

The device type may be determined by receiving a transmission from the device and comparing characteristics of the transmission with known characteristics of a list of known devices.

The list of known devices may be categorized by characteristics and the characteristics of the transmission are compared to the categories before being compared to individual devices.

The data encryption may be achieved through a stream cipher encryption scheme, wherein the stream cipher encryption scheme is dependent upon the data to be encrypted.

The one or more processors may be virtual processors.

### EXAMPLE

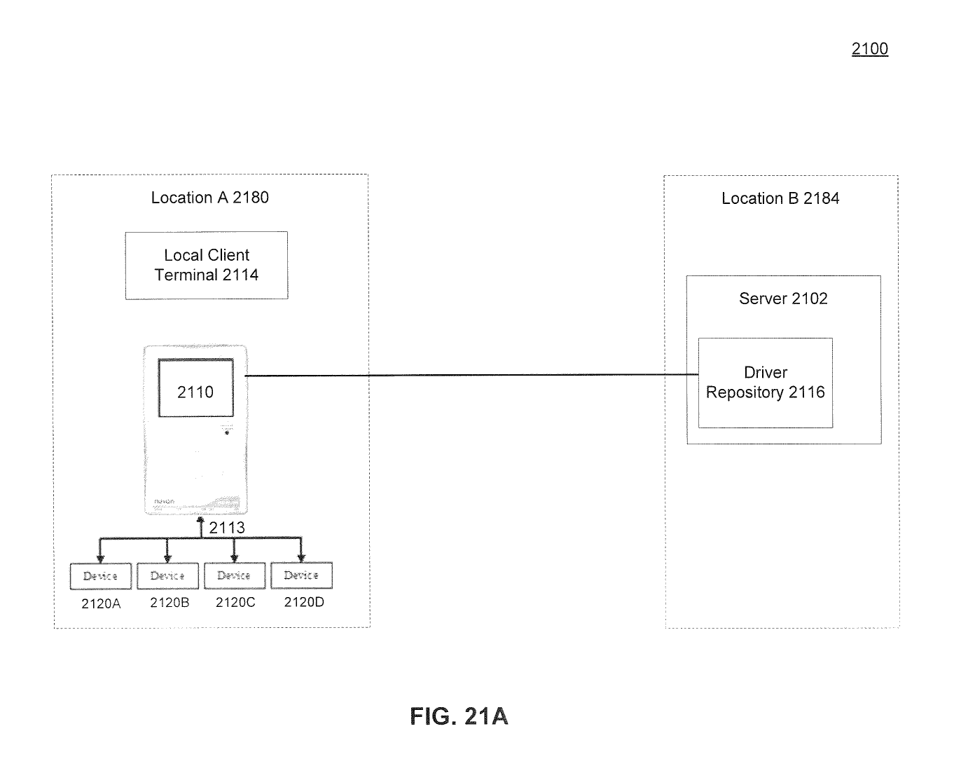

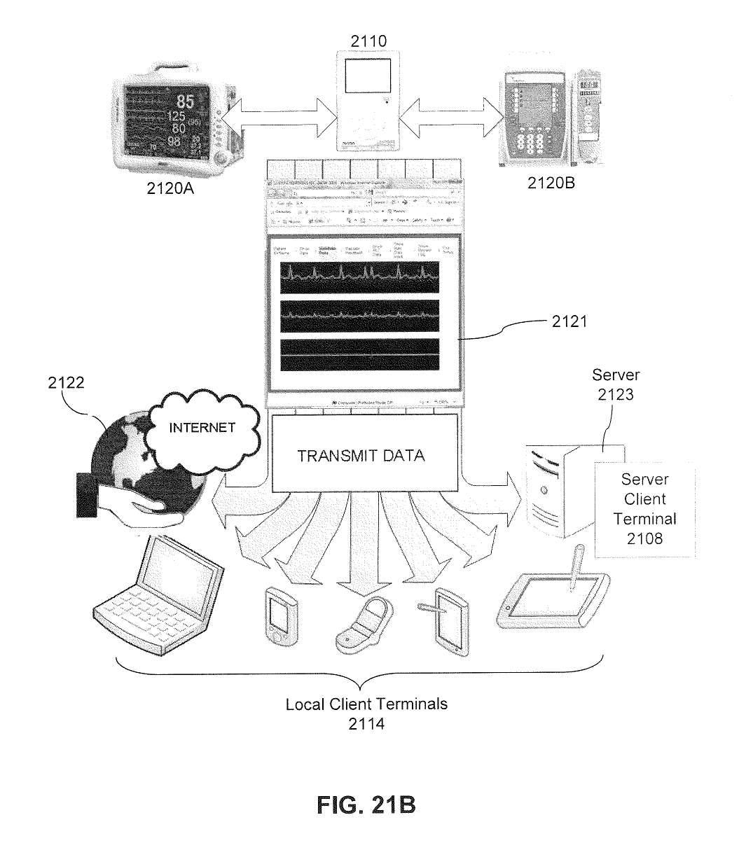

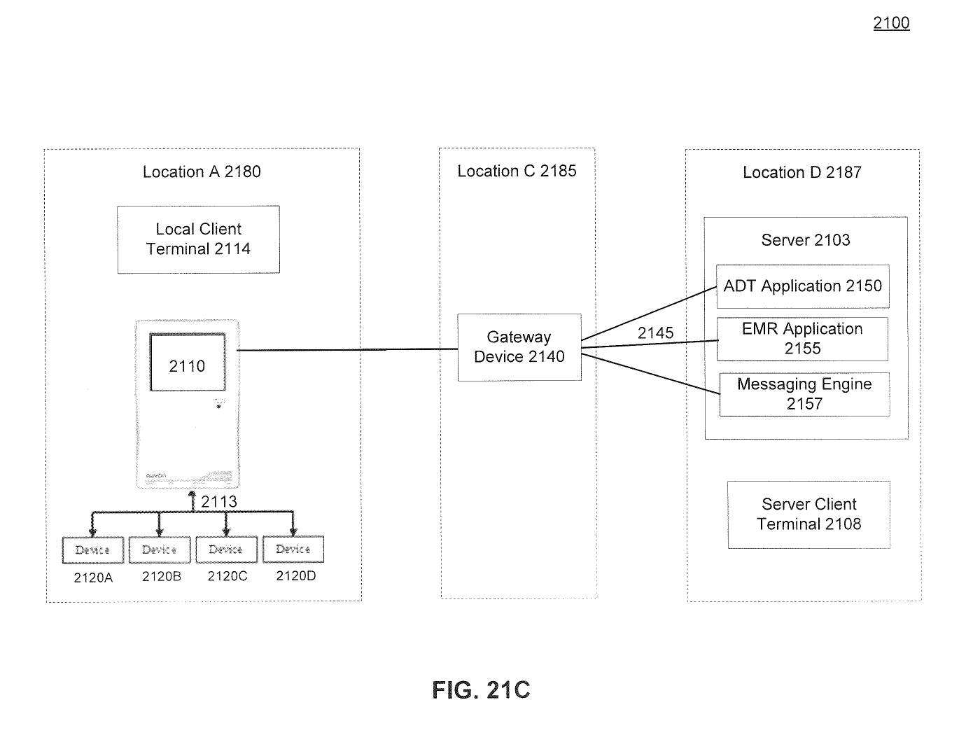

FIGS. 21A-C through 28 illustrate an embodiment of a device manager, such as device manager 1610, as described with FIGS. 19A-C above. Referring to FIGS. 21A-C, in an example, not to be limiting, device manager 2110 is an INTELLIGENT DEVICE MANAGER MEDICAL GRADE APPLIANCE model 1000 (IDM-MG 1000), from NUVON, Inc. of San Francisco, Calif.

As depicted on FIGS. 21A-C through 28, a device manager described herein, such as device manager 2110, can be used for various biomedical applications and have various features. A list of example applications, not to be limiting, includes:

A1. Automatic configuration of connections with biomedical devices;

A2. Automatic discovery of biomedical devices;

A2. Intelligent monitoring of biomedical devices;

A3. Notification of events associated with the monitoring of biomedical devices;

A4. Automatic management of enterprise transmission modes

A5. Automatic management of external transmission modes

A6. The reception and transmission of data using multiple channels;

A7. The reception and transmission of data using HL7, IHE and PCD compliant nomenclature standards; and

A8. The use of radio frequency identification (RFID) and tracking options with low-power automation wireless protocol (IEEE 802.15.4) ZigBee.

This example of applications/features A1-A8 is illustrative and not intended to limit embodiments described herein. Embodiments of device manager 2110 may perform functions A1-A8 individually, or in combination. As would be apparent to a person skilled in the art given this description, other applications and features may be performed by device manager 2110 given the characteristics of embodiments described herein.

As depicted on FIG. 21A, device manager 2110 in one embodiment may be a networked hardware device connected to a biomedical devices 2120A-D via connection 2113. In FIG. 21A, two locations are shown, location A 2180, location B 2184. These example locations are illustrative of example component placement and not intended to be limiting. In embodiments, any combination of locations may be proximate in the same geographical space, or any combination can be geographically disparate.

In one embodiment, biomedical devices 2120A-D may connect to device manager 2110 via one or more different network connection protocols, such protocols varying in hardware, software, or a combination of the two. In one aspect, examples of connection protocols used by device manager 2110 include, but are not limited to, unidirectional or bidirectional Ethernet/local area network (LAN), wireless local area network (WLAN), universal serial bus (USB), wireless universal serial bus (Wireless USB), parallel interface, RS-232 serial interface, RS-422 serial interface, RS-485 serial interface (Modbus; Profibus), FireWire, universal asynchronous receiver/transmitter (UART), small computer system interface (SCSI), WiFi, Zigbee, Bluetooth, radio frequency (RF), infrared (IR), is fiber optic, high-definition multimedia interface (HDMI), S-video, RCA connector, TRS connector, coaxial cable, hypertext transfer protocol (HTTP), file transfer protocol (FTP), internet protocol suite (TCP/IP), open systems interconnection (OSI), universal plug and play (UPnP), internet SCSI (iSCSI), network file systems protocol, or simple object access protocol (SOAP).

In one embodiment, the device manager 2110 may automatically determine the types of the devices 2120 connected via connection 2113 for the purposes of setting a communication protocol. In an embodiment, the automatic determination may be implemented by use of a detection algorithm, and the detection algorithm can use a listing of the characteristics of known devices. In an embodiment, device manager 2110 may be programmed to transmit and/or receive a query and analyze a response or received transmission, and based upon the received response to a query, device manager 2110 can analyze the response and compare the characteristics of the transmission to the listing of characteristics of known devices. In an example, this comparison allows for the automatic determination of the type of connected device 2120A-D. In one aspect, from the list of known devices, the devices may be categorized based upon various characteristics or traits, such as data transmission protocols.

In a non-limiting example, a biomedical device such as a ventilator is connected to device manager 2110 using connection 2113. Device manager 2110 assesses the communication speed between the biomedical device and itself. A basic hardware connection can be established at this point in the example by the setting of port parameters based on the communication speed between device 2120 and device manager 2110.

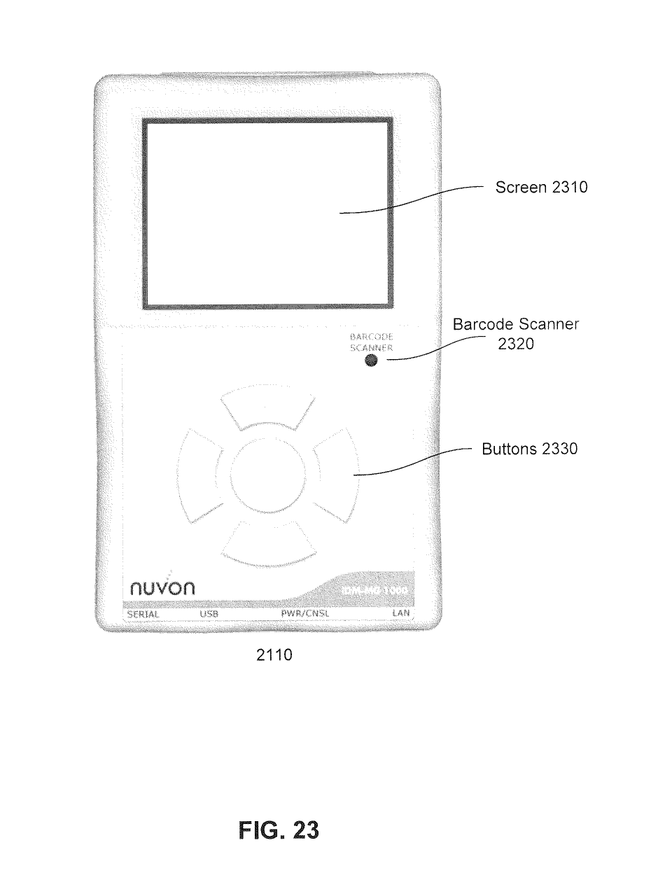

In this example, once a basic hardware connection is made using device manager 2110, an initial character stream is received by device manager 2110 from the biomedical device. Device manager 2110 attempts to determine the specific connected device by comparing these received initial characters with the initial characters of known devices. If this comparison is unsuccessful, device manager 2110 narrows down the potential types of devices based upon the initial characters received. In an embodiment, this determination by analysis of exchanged signals is termed “auto discovery” or “automatic discovery.” In an embodiment, if a device is not found, then manual entry may be performed using screen 2310 and buttons 2330 on device manager 2110 as depicted on FIG. 23.

In an embodiment, different device drivers used by device manager 2110 to interact with different devices 2120A-D, are stored in a designated location in the network system 2100, such as in driver repository 2116 on server 2102. In an embodiment, server 2102 stores all or some of the available device drivers used by device manager 2110, and may be configured to automatically transfer specific device drivers to a specific device manager 2110 based upon which devices 2120 are connected to device manager 2110. In an example, not to be limiting, server 2102 is a NUVON VEGA SERVER, from NUVON, Inc. of San Francisco, Calif., and this example server 2102 has an example driver repository 2116—“a NUVON CORE MODULE” that provides the above described infrastructure for the automatic configuration of device manager 2110.

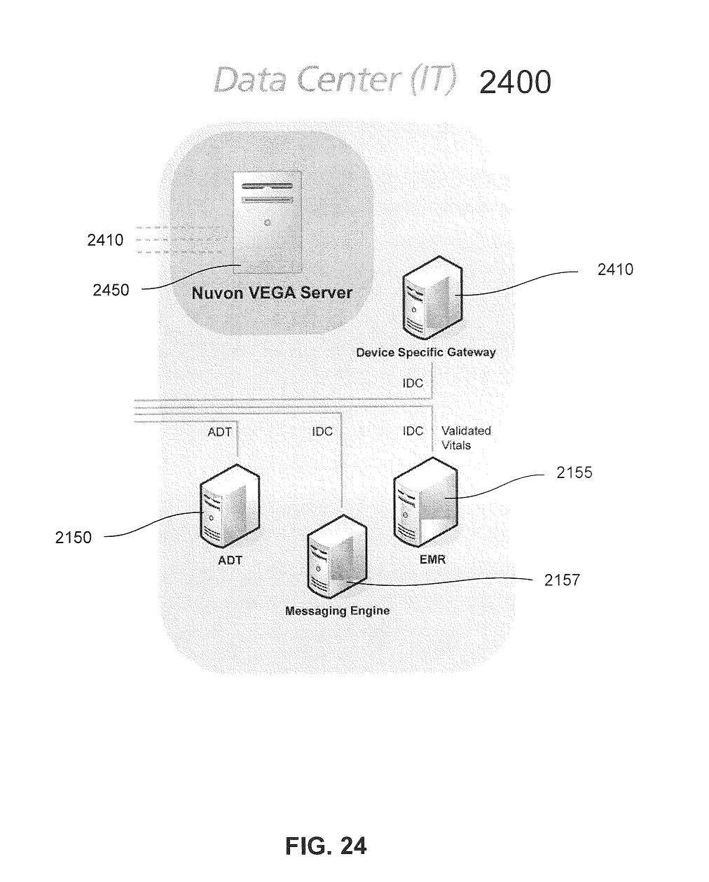

In an example intended to be non-limiting, FIG. 24 depicts data center (IT) 2400 having a server 2450, such as a NUVON VEGA SERVER, connected to external devices via connection 2410, such server having substantially similar functionality and structure to server 2102 from FIG. 21A. Still referring to FIG. 24, data center 2400 further includes a device specific gateway 2410, an admission/discharge/transfer (ADT) application 2150, messaging engine 2157 and electronic medical record (EMR) application 2155. Device specific gateway 2410 has substantially similar functionality and structure to driver repository 2116 from FIG. 21A.

In an embodiment, after a connection is established between device manager 2110 and device 2120, a positive patient identification (PPI) is established before device manager 2110 is fully operable to transmit data. In embodiments, this PPI can be accomplished by device manager 2110 in several ways. One example method, not intended to be limiting, is for a user to utilize barcode scanner 2320, as depicted on FIG. 23, to scan a barcode from a patient's identification bracelet. Another example method, not intended to be limiting, is for a user of device manager 2110 to utilize buttons 2330 to enter a patient's identifying code or characteristics. Establishing PPI allows device manager 2110 to send data linked to a specific patient for further processing as described below.

FIG. 21B illustrates the transferring of data over a network by an embodiment of device manager 2110. Referring to FIG. 21B, in one embodiment, device manager 2110, such as device managers as described above, is in operational communication with one or more network devices 2120. Network devices 2120, in one embodiment, are configured for operations such as, among others, monitoring, measuring, mechanical operation, displaying, or combinations thereof, and in an embodiment, network devices 2120 are not initially configured for network communication.

In an embodiment, data 2121 associated with network devices 2120 is monitored by device manager 2110 via the following non-limiting list of techniques: wired network protocols, wireless network protocols, power monitoring (by, for example, voltage or current monitoring), ambient conditions measurements (such as temperature or other physical conditions monitoring) or through the use of third party measurement devices, such as standard or infrared cameras, or a combination thereof.

Communication protocols and methods used in an embodiment of device manager 2110 may include, but are not limited to, wired or wireless communication such as WiFi, 802.11x, RF, Bluetooth, Zigbee, USB, Wireless USB, Firewire, Ethernet, RS-232, RS-422, or RS-485 serial interfaces, and the like. One having skill in the art, and given the description herein, will recognize that other communications protocols can be used by device manager 2110.

In an embodiment, data 2121 associated with network devices 2120 may be in the form of graphical data, electronic signals data, numerical data, audio data, video data, waveforms, analog values representing physical measurements, or a combination thereof. In one embodiment, data 2121 may correspond to, for example, human physical data (such as electrocardiography (EKG) heart data, blood pressure readings, blood sugar readings, oxygen saturation (SpO₂) data, Electroencephalography (EEG) brain activity, drug concentration information, etc.), ambient data readings (such as earthquake monitoring data, ambient temperature and pressure readings, etc.), gas concentrations (such as radon, oxygen, carbon dioxide, etc.), or a combination thereof. One having skill in the art, and given the description herein, will recognize that other types and forms of data can be collected, transmitted and received by device manager 2110.

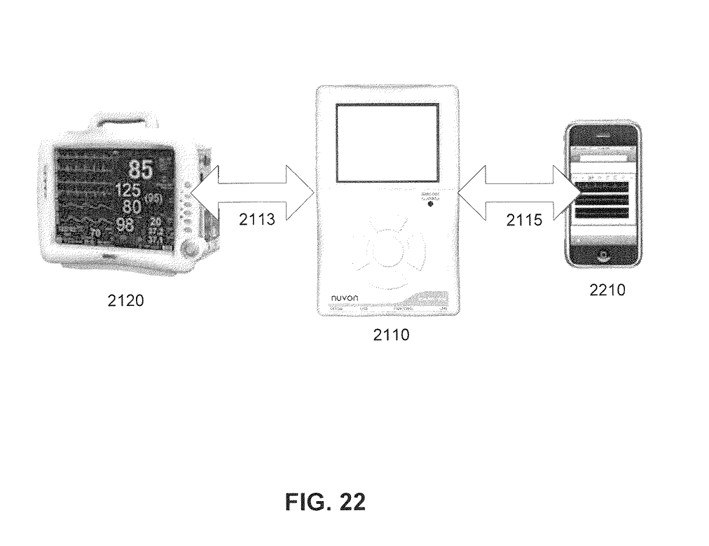

Referring still to FIG. 21B, in an embodiment, device manager 2110 can be in operational communication with one or more local client terminals 2114, networks 2122, such as the Internet, servers 2123, or combinations thereof, and data 2121 associated with the network devices 2120 can be forwarded to one or more local client terminals 2114, networks 2122, and servers 2123. FIG. 22 depicts device manager 2110 linked via connection 2113 to device 2120, and via connection 2115 to mobile device 2210.

In an embodiment, data 2121 is forwarded to a server 2123 for distribution across a network to one or more server client terminals 2108, and in this embodiment, data 2121 received at server 2123 may be stored in a database as historical data and/or may be further forwarded to a server client terminal 2108 for viewing, monitoring, and/or adjustment by a user. Server client terminal 2108 may be in communication with server 2123 directly via wired or wireless connection protocols, or may be in communication with server 2123 through a network, either a local network or intranet, or via a network such as the internet.

In another embodiment, device manager 2110 is configured as part of an ad-hoc network. In such a configuration, device manager 2110 can be configured to forward data directly and in substantially real-time to local client terminal 2114. Local client terminal 2114, in one embodiment, may be a device including, but to not limited to, a computer, a laptop computer, a personal digital assistant (PDA), a cellular telephone, a smart telephone, a tablet, and the like.

In yet another embodiment, device manager 2110 is configured to transmit data 2121, such as real-time or substantially real-time waveforms, simultaneously or substantially simultaneously to more than one end location, for example, to local client terminal 2114 and server 2123. In such a configuration, data 2121 associated with network devices 2120A-B may be transmitted to local client terminal 2114 for real-time monitoring by a user, while substantially simultaneously being transmitted to a server 2123 for storage as historical data. In another configuration, data 2121 may be transmitted to server client terminal 2108 substantially simultaneously and in substantially real-time for monitoring by more than one remote user.

Referring still to FIG. 21B, data 2121 forwarded by device manager 2110 may be provided to local client terminal 2114 in a variety of formats. The chosen format may be determined by device manager 2110 based upon configuration communication between device manager 2110 and local client terminal 2114. In one aspect, device manager 2110 may be configured to detect the types of formats local client terminal 2114 is configured to accept, such format types including, but not being limited to: text, numerical lists, XML, HTML, Java Architecture for XML Binding (JAXB), images (such as jpeg, gif, or png), video (such as avi, mpeg, wmv, or mkv), portable document format (PDF), numerical database, or a combination thereof. In another embodiment, device manager 2110 and its network system may be configured with security protocols. For example, data 2121 associated with network devices 2120A-B, in an embodiment, may be encrypted by device manager 2110 before transmission to local client terminal 2114 or server 2123. Furthermore, in an embodiment, local client terminal 2114 or server 2123 may be configured to decrypt the encrypted received data. In another aspect, security may be implemented to validate the operational connections between network devices 2120A-B, device manager 2110, server 2123, and local client terminal 2114.

In FIG. 21C, three locations are shown, location A 2180, location C 2185 and location D 2187. These example locations are illustrative of example component placement and not intended to be limiting. In embodiments, any combination of the three locations may be proximate in the same geographical space, or any combination can be geographically disparate.

In an embodiment, device manager 2110 may be set up in a peer-to-peer mode for mutual data exchange with connected devices 2120, or another device manager having substantially similar functionality and structure to device manager 2110 (not shown). Device manager 2110 may be configured to monitor, analyze, convert, filter and/or transform data streams received from connected devices 2120, or receive and generate device specific events, such as alarms, warnings, or maintenance requests.

In another embodiment, data received from devices 2120 may be monitored, analyzed, converted, filtered, and/or transformed in real-time. In other embodiments, data received by device manager 2110 from devices 2120 may be monitored, analyzed, converted, filtered, and/or transformed continuously, periodically, or discretely.

In an embodiment, device manager 2110 can be connected to a gateway device 2140. Gateway device 2140 can be configured to receive data from device manager 2110, convert it into another protocol for transmission, and transfer the data from device manager 2110 to another device. In other embodiments, no gateway device 2140 is required to send and receive data to and from other systems. In an example, not intended to be limiting, gateway device 2140 is an INTELLIGENT DEVICE MANAGER MEDICAL GRADE APPLIANCE model 4000 (IDM-MG 4000), from NUVON, Inc. of San Francisco, Calif., and the server can send and receive data using the Health Level 7 (HL7) protocol.

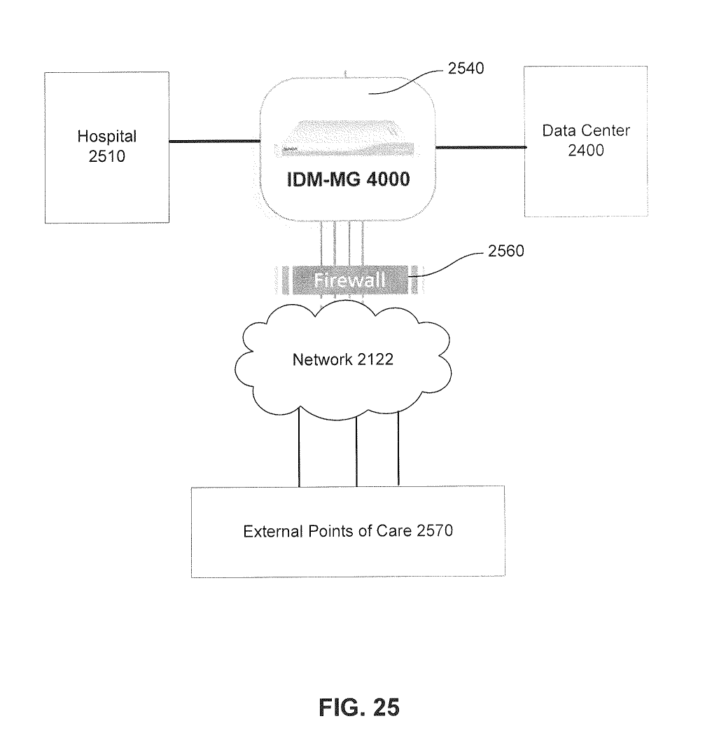

FIG. 25 depicts an embodiment where gateway device 2540, such as a NUVON IDM-MG 4000 gateway device, is connected to hospital 2510, data center 2400 and external points of care 2570. In this embodiment, the connection to external points of care 2570 is through protective firewall 2560 via network 2122, network 2122 for example being the Internet.

Returning to FIG. 21C, in one embodiment, data received by device manager 2110 from devices 2120 may be transmitted to server 2123, where it can be routed to admission/discharge/transfer (ADT) application 2150, Electronic Medical Record (EMR) application 2155 and/or messaging engine 2157.

In another configuration, the data received from devices 2120 may be transmitted to a dedicated memory (not shown) for storing data received from devices 2120. In an embodiment, transmission and reception of data to and from device manager 2110 may be achieved via wired or wireless communication.

In one embodiment of device manager 2110, alarms or warnings may be generated in the form of a data stream sent to an external device. In another embodiment of device manager 2110, alarms or warnings may be generated in the form of a visual, auditory, or tactile alarms or warnings or a combination thereof. In one aspect of an embodiment, the visual, auditory, or tactile alarms or warnings may be executed at local client terminal 2114 or a server client terminal 2108. In another aspect, the visual, auditory, or tactile alarms or warnings may be executed at device manager 2110. In another embodiment, the visual, auditory, or tactile alarms or warnings may be executed at one or more devices 2120. In another aspect, the visual, auditory, or tactile alarms or warnings may be executed at a dedicated alarm device (not shown) on the network.

Example Environments in which Embodiments can be Used

The following section provides non-limiting examples in which embodiments of a device manager, such as device manager 2110, can be used.

Hospital Environment (Clinical)

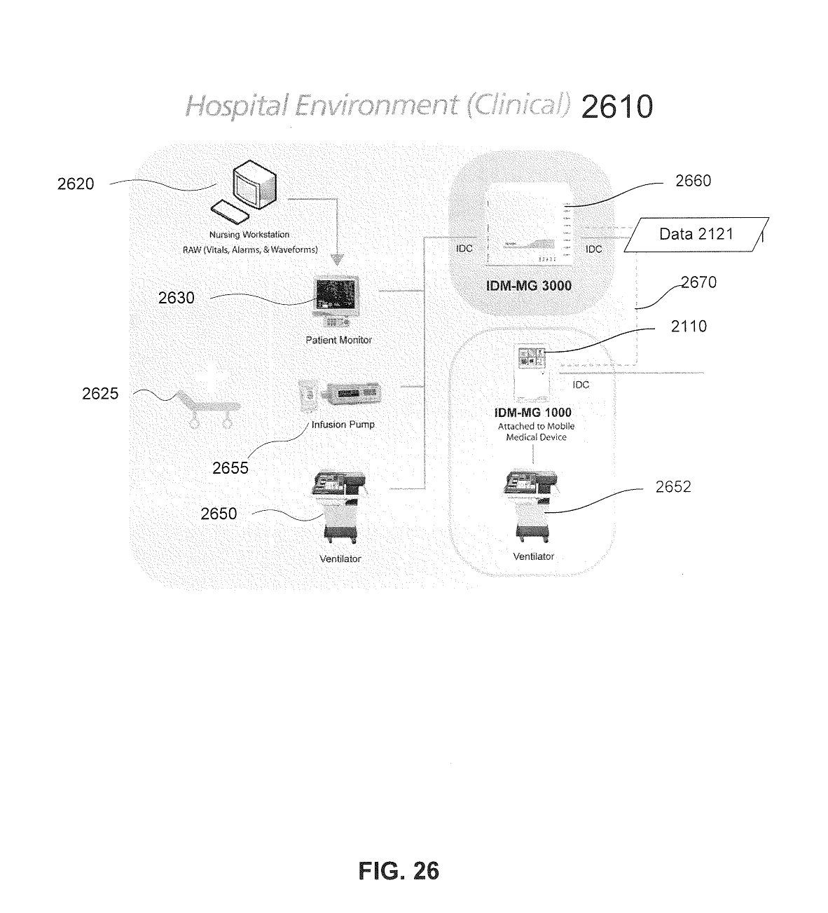

FIG. 26 depicts an example hospital environment 2610 where device manager 2110 and system 2100 can be utilized. In an example, once a patient 2625 is admitted and moved from an Emergency Department, permanent appliance 2660 may be used. Permanent appliance 2660 may be designed to reside at the bedside or in networked environments to transmit medical device data 2121 to an EMR application 2125 (FIG. 21C) with positive patient identification (PPI), as noted above with the discussion of FIG. 21A. In this scenario PPI may be achieved either through barcode scanning or 2-way ADT communication. In an example, not intended to be limiting, permanent appliance 2660 is an INTELLIGENT DEVICE MANAGER MEDICAL GRADE APPLIANCE model 3000 (IDM-MG 3000), from NUVON, Inc. of San Francisco, Calif. In an embodiment, permanent appliance 2660 has substantially similar functionality and structure to device manager 2110.

In the example of FIG. 26, devices 2120 include patient monitor 2630, infusion pump 2655, ventilator 2650 and mobile ventilator 2652. In this example, device manager 2110 is linked to mobile ventilator 2652 and provides collected data wirelessly via wireless connection 2670.

EMT Environment

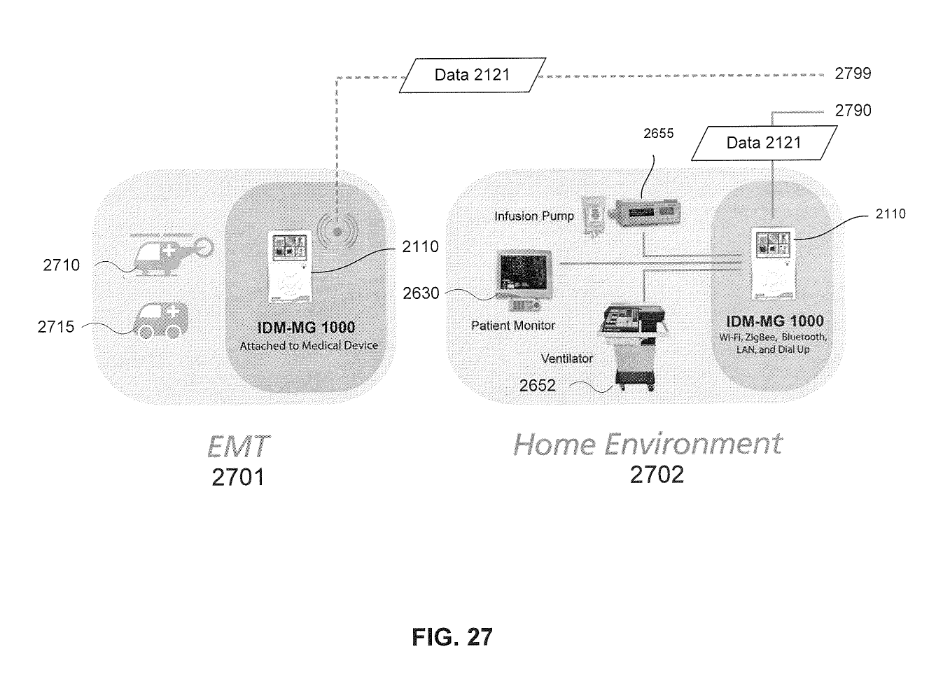

In an embodiment, FIG. 27 depicts an example emergency medical technician (EMT) environment 2701 where device manager 2110 and system 2100 can be utilized. From the moment an EMT vehicle (2710, 2715) arrives at a patient's location, and device 2120 (FIG. 21C) is attached, manager 2110 can start collecting data 2121 and transmitting that data via wireless connection 2799 to, for example, an emergency department in hospital environment 2610 in real time. If, in a non-limiting example, data 2121 is not able to be transmitted while the patient is in transit in EMT vehicle (2710, 2715), device manager 2110 can store the data, and once the patient is assigned a bed 2625 (FIG. 26) the data stored within device manager 2110 is associated to patient 2625 and the data flows into the patient's Electronic Medical Record (EMR) 2155 (FIG. 21C). In this example, by utilizing device manager 2110, the communication of data 2121 between EMT 2701 and hospital environment 2610 either will remain consistent throughout the process by wireless transmission 2799, or will be transmitted to EMR 2155 upon arrival at hospital environment 2610. In an embodiment, device manager 2110 allows for a faster, more complete response by medical staff.

Home Environment

FIG. 27 further depicts the example use of device manager 2110 in home environment 2702. In an embodiment, once the patient is ready to be discharged, and additional devices 2120 are required, the patient is sent home with a device manager attached to devices 2120 (e.g., patient monitor 2630, ventilator 2652 and infusion pump 2655). In an embodiment, a positive identification, e.g., PPI described above with the description of FIG. 21A, is established before device manager 2110 is fully operable. In an embodiment, device manager 2110 proceeds to collect data from devices 2120 and transmit data 2121 to EMR 2155 in transit (not shown) and via wired connection 2790, e.g., a telephone line data connection, when the patient arrives at home environment 2702. In an embodiment, device manager 2110 can be used in this scenario until consistent monitoring of the patient is no longer required. In another example, the approach to monitored transit and consistent monitoring by device manager 2110 can be applied to both an ambulatory care center environment 2704 and a secondary acute care facility environment 2703.

Method

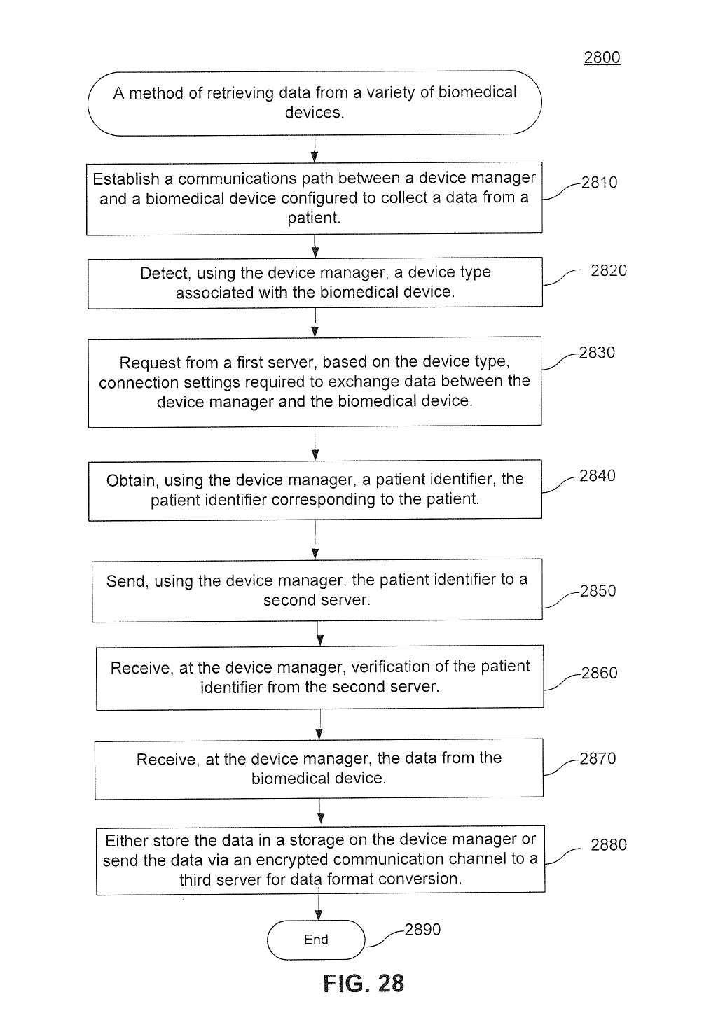

This section and FIG. 28 summarize the techniques described herein by presenting a flowchart of an exemplary method 2800 for retrieving data from a variety of biomedical devices. While method 2800 is described with respect to an embodiment of the present invention, method 2800 is not meant to be limiting and may be used in other applications.

As shown in FIG. 28, an embodiment of method 2800 begins at step 2810 where a communications path is established between a device manager and a biomedical device configured to collect data from a patient. In an embodiment, a communications path, such as connection 2113 is established between a device manager, such as device manager 2110, and a biomedical device, such as device 2120A. Once step 2810 is complete, method 2800 proceeds to step 2820.

At step 2820, the device manager is used to detect a device type associated with the biomedical device. In an embodiment, a device manager, such as device manager 2110, is used to detect a device type associated with the biomedical device, such as device 2120A. Once step 2820 is complete, method 2800 proceeds to step 2830.

At step 2830, a request is made from a first server, based on the device type, for connection settings required to exchange data between the device manager and the biomedical device. In an embodiment, a request is made from a first server, such as server 2102, based on the device type, such as the type of device 2120A, for connection settings required to exchange data between the device manager, such as device manager 2110, and the biomedical device, such as device 2120A. Once step 2830 is complete, then method 2800 continues to step 2840.

At step 2840, the device manager obtains a patient identifier, the patient identifier corresponding to the patient. In an embodiment, the device manager, such as device manager 2110, obtains a patient identifier, the patient identifier corresponding to the patient. Once step 2840 is complete, then method 2800 continues to step 2850.

At step 2850, the device manager sends the patient identifier to a second server. In an embodiment, the device manager, such as device manager 2110, sends the patient identifier to a second server, such second server corresponding to server 2103. The second server may be the same as the first server. Once step 2850 is complete, then method 2800 continues to step 2860.

At step 2860, the device manager receives verification of the patient identifier from the second server. In an embodiment, the device manager, such as device manager 2110, receives verification of the patient identifier from the second server, such as server 2103. Once step 2860 is complete, then method 2800 continues to step 2870.

At step 2870, the device manager receives the data from the biomedical device. In an embodiment, the device manager, such as device manager 2110, receives the data from the biomedical device, such as device 2120A. Once step 2870 is complete, then method 2800 continues to step 2880.

In step 2880, the data is either stored in a storage on the device manager or the data is sent via an encrypted communication channel to a third server for data format conversion. In an embodiment, the data is either stored in a storage on the device manager, such as device manager 2110, or the data is sent via an encrypted communication channel to a third server, such as gateway device 2140, for data format conversion, such as a conversion to HL7 format. Once step 2880 is complete, method 2800 ends.

Steps 2810, 2820, 2830, 2840, 2850, 2860, 2870 and 2880 may be implemented as software, hardware, firmware, or any combination.

### CONCLUSION

Embodiments described herein a network system with a plurality of networked devices with various connection protocols. The summary and abstract sections may set forth one or more but not all exemplary embodiments of the present invention as contemplated by the inventors, and thus, are not intended to limit embodiments and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within is the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A device manager, comprising:
one or more processors;
a communication interface coupled to the one or more processors; and
a memory for storing instructions which, when executed by the one or more processors, causes the one or more processors to:
detect one or more devices connected to the communication interface;
determine a device type associated with each of the one or more devices;
receive data from the one or more devices;
encrypt the data received from the one or more devices; and
transmit the encrypted data to a network data storage device configured for accessibility by one or more remote terminals.

2. The device manager of claim 1, wherein the one or more processors include application programming interface (API) extensions.

3. The device manager of claim 2, wherein the API extensions include direct memory access extensions.

4. The device manager of claim 1, wherein the one or more processors are 8051 microcontrollers.

5. The device manager of claim 4, wherein the one or more processors include direct memory access extensions.

6. The device manager of claim 1, wherein the memory for storing instructions which, when executed by the one or more processors, causes the one or more processors to detect one or more devices connected to the communication interface, wherein the one or more devices are legacy devices not initially configured for network communication.

7. The device manager of claim 6, wherein the data received from the one or more legacy devices is power consumption data.

8. The device manager of claim 7, wherein the memory for storing instructions which, when executed by the one or more processors, causes the one or more processors to convert the power consumption data into device function data.

9. The device manager of claim 8, wherein converting the power consumption data into device function data is achieved through the use an algorithm specific to the device type associated with the device.

10. The device manager of claim 1, wherein the device type is determined by receiving a transmission from the device and comparing characteristics of the transmission with known characteristics of a list of known devices.

11. The device manager of claim 10, wherein the list of known devices are categorized by characteristics and the characteristics of the transmission are compared to the categories before being compared to individual devices.

12. The device manager of claim 1, wherein the data encryption is achieved through a stream cipher encryption scheme, wherein the stream cipher encryption scheme is dependent upon the data to be encrypted.

13. The device manager of claim 1, wherein the one or more processors are virtual processors.

14. A method, comprising:
detecting one or more devices connected to a communication interface;
determining a device type associated with each of the one or more devices;
receiving data from the one or more devices;
encrypting the data received from the one or more devices; and
transmitting the encrypted data to a network data storage device configured for accessibility by one or more remote terminals.

15. The method of claim 14, wherein detecting the one or more devices includes detecting one or more legacy devices not initially configured for network communication.

16. The method of claim 15, wherein receiving data from the one or more legacy devices includes receiving power consumption data.

17. The method of claim 16, further comprising converting the power consumption data into device function data.

18. The method of claim 17, wherein converting the power consumption data into device function data is achieved through the use an algorithm specific to the device type associated with the device.

19. The method of claim 14, wherein the device type is determined by receiving a transmission from the device and comparing characteristics of the transmission with known characteristics of a list of known devices.

20. The method of claim 19, wherein the list of known devices are categorized by characteristics and the characteristics of the transmission are compared to the categories before being compared to individual devices.

21. The method of claim 14, wherein encrypting the data comprises using a stream cipher encryption scheme, wherein the stream cipher encryption scheme is dependent upon the data to be encrypted.

22. A method of retrieving data from a variety of biomedical devices comprising:
establishing a communications path between a device manager and a biomedical device configured to collect a data from a patient;
detecting, using the device manager, a device type associated with the biomedical device;
requesting from a first server, based on the device type, connection settings required to exchange data between the device manager and the biomedical device;
obtaining, using the device manager, a patient identifier, the patient identifier corresponding to the patient;
sending, using the device manager, the patient identifier to a second server;
receiving, at the device manager, verification of the patient identifier from the second server;
receiving, at the device manager, the data from the biomedical device; and
either storing the data in a storage on the device manager or sending the data via an encrypted communication channel to a third server for data format conversion.

23. The method of claim 22 wherein the second server is the same as the first server.
